(19) United States
(12) Patent Application Publication
(10) Pub. No.: US 2023/0357461 A1
(43) Pub. Date: Nov. 9, 2023

(54) ULTRA-HIGH MOLECULAR WEIGHT POLYMERS AND METHODS OF USING THE SAME

(71) Applicant: University of Florida Research Foundation, Inc., Gainesville, FL (US)

(72) Inventors: Cullen Lee Garrett Davidson, Gainesville, FL (US); Megan Lott, Gainesville, FL (US); Rebecca Olson, Gainesville, FL (US); Diego Ivan Pedro, Gainesville, FL (US); Wallace Gregory Sawyer, Gainesville, FL (US); Brent S Sumerlin, Gainesville, FL (US)

(21) Appl. No.: 18/140,910

(22) Filed: Apr. 28, 2023

Related U.S. Application Data
(60) Provisional application No. 63/336,733, filed on Apr. 29, 2022.
(60) Provisional application No. 63/368,404, filed on Jul. 14, 2022.

(51) Int. Cl. C08F 120/56; C08L 33/26

(52) U.S. Cl. CPC C08F 120/56; C08L 33/26

(57) ABSTRACT

The present disclosure provides for compositions including at least one type of water-soluble polymer having a molecular weight of about 10 kDa to 10,000 kDa, methods of making the water-soluble polymer, structures having the water-soluble polymer disposed thereof, and methods of use thereof. The present disclosure provides for branched and hyperbranched water-soluble polymers and methods of making branched and hyperbranched water-soluble polymers.

### CLAIM OF PRIORITY TO RELATED APPLICATION

This application claims priority to co-pending U.S. provisional application entitled “ULTRA-HIGH MOLECULAR WEIGHT POLYMERS AND METHODS OF MAKING AND USING THE SAME” having Ser. No. 63/336,733, filed on Apr. 29, 2022, which is entirely incorporated herein by reference. In addition, this application claims priority to co-pending U.S. provisional application entitled “ULTRA-HIGH MOLECULAR WEIGHT POLYMERS AND METHODS OF MAKING AND USING THE SAME” having Ser. No. 63/368,404, filed on Jul. 14, 2022, which is entirely incorporated herein by reference.

### BACKGROUND

The eye's first line of defense against the external environment is a thin stratified layer of moist epithelial cells at the surface of the cornea which are shielded by an aqueous and mucinous tear film. Ocular health, durability, and comfort are inexorably linked to the ability of these epithelial cells to produce mucins to form the glycocalyx and stabilize the tear film. Ocular mucins contribute to homeostasis on the ocular surface, maintain clarity of the cornea and the tear film, and provide a physical barrier of protection against foreign debris (e.g., pathogens, toxins, and particles) while permitting the rapid passage of selected gases, fluids, ions, and nutrients.

The cornea and conjunctiva express lower molecular weight membrane-spanning mucins (MUC1, MUC4, MUC16, and MUC20), which anchor the secretory and gel-forming mucins (MUC2, MUC5AC) produced by goblet cells found in the conjunctival epithelia. The mucins present in the tear film (MUC1, MUC2, MUC4, MUC5AC, and MUC16) together form a gel layer that serves to maintain hydration and clarity of the ocular surface, provide lubrication, and resist adhesion between the corneal and conjunctival epithelia during an eyeblink.

These mucins create a gel-spanning hydrogel network, called the glycocalyx, which stabilizes the tear film and prevents dewetting. This gel network is primarily crosslinked through physical crosslinks, as opposed to chemical crosslinks. Critically, the weak physical crosslinks and the large mesh-size of mucin gels result in a surface with an intrinsically low shear stress during sliding and a low yield stress. The physical crosslinks break and heal dynamically under conditions when the yield stress is exceeded (e.g., during blinking); the gel spanning mucin network acts like a mechanical fuse limiting the potentially damaging level of stress that can be transmitted to the underlying epithelial cells.

Table 1 shows a list of the mucins found in the ocular environment. This wide array of mucins function as a system to create a gel spanning network with finite yield stress, shear thinning, and maintain a smooth and uniform film thickness across the optical interface. Gel-forming and soluble mucins are not formed by corneal epithelial cells.

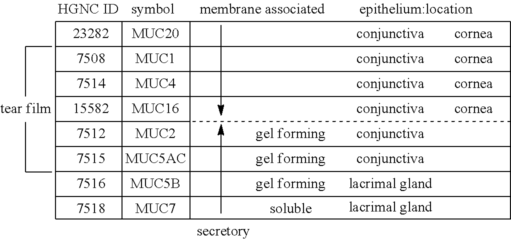

The eyes are rarely at rest during waking hours and blink about 20,000 times in a day. During a blink, the eyelid wiper accelerates to a maximum speed of approximately 100 mm/s, approaches the lower eyelid, and then retracts back; the entire process takes place in ˜100 milliseconds. The contact pressure exerted on the cornea by the eyelid during this activity has not been directly measured but is thought to be on the order of 1-5 kPa.

A schematic of the corneal epithelium, tear film, mucins associated with the ocular surface, including mucin MUC20 secreted between cells, and the waxy lipid layer is shown schematically in the inset of FIG. 1. The tear film (˜5 μm thickness) covers the corneal epithelial cells of the ocular surface (˜55 μm thickness). The lipid rafts (50-100 nm in thickness) are produced by meibomian glands at the rim of the eyelids and are thought to impede evaporation of the tear film and prevent fine dust and debris from entering the ocular environment. The inset also illustrates the large molecular weight and complex structure of secretory and gel-forming mucins, as well as soluble, tear film mucins. The ultrastructure of the corneal epithelium and detail of the microvilli on the surface of the stratified squamous epithelium increase the surface area for secreting membrane-bound mucins MUC1, MUC4, and MUC16. Together these mucins anchor the secretory and soluble mucins and form a bio-polymer hydrogel, called the glycocalyx, which stabilizes the tear film and prevents dewetting. Dry eye discomfort may have an underlying etiology that involves frictional shear stresses exceeding physiological levels that can be well tolerated. The quality of the tear film is critically important for both of these applications.

### SUMMARY

The present disclosure provides for compositions including at least one type of water-soluble polymer having a molecular weight of about 10 kDa to 10,000 kDa, methods of making the water-soluble polymer, structures having the water-soluble polymer disposed thereof, and methods of use thereof. The present disclosure provides for branched and hyperbranched water-soluble polymers and methods of making branched and hyperbranched water-soluble polymers.

The present disclosure provides for a synthetic method of making a first water-soluble polymer, comprising: polymerizing a backbone unit and at least one mucin-binding unit to form the first water-soluble polymer of using photoiniferter polymerization under inverse miniemulsion conditions. In an aspect, the method is a catalyst-free heterogeneous process that is mediated using low-intensity UV irradiation.

The present disclosure provides for a synthetic method of making a branched or hyperbranched first water-soluble polymer, comprising: polymerizing a backbone unit and at least one mucin-binding unit to form the branched or hyperbranched first water-soluble polymer, wherein the branched or hyperbranched first water-soluble polymer has a molecular weight of about 10 kDa to 10,000 kDa, wherein the branched or hyperbranched first water-soluble polymer includes a plurality of backbone units and at least one first type of a mucin-binding unit, wherein the backbone units comprise greater than 50% of the first water-soluble polymer based on molecular weight, wherein the first type of mucin-binding unit comprises of 1 unit up to 50% of the first water-soluble polymer based on molecular weight, wherein the first type of mucin-binding unit is functionalized so the water-soluble polymer has the characteristic of altering the hydration, rheology, or both of a mucin polymer, a second water-soluble polymer, or a combination thereof, wherein altering the hydration, rheology, or both is achieved through mucoadhesion, mucolability, mucointegration, or a combination thereof.

The present disclosure provides for a composition, comprising a first branched or hyperbranched water-soluble polymer having a molecular weight of about 10 kDa to 10,000 kDa, wherein the first branched or hyperbranched water-soluble polymer includes a plurality of backbone units and at least one first type of a mucin-binding unit, wherein the backbone units comprise greater than 50% of the first branched or hyperbranched water-soluble polymer based on molecular weight, wherein when the branched or hyperbranched first water-soluble polymer is formed the backbone unit is the reaction product of a multifunctional water soluble monomer and a water soluble monofunctional unit, wherein the mol % of the multifunctional water soluble monomer is less than 1% relative to the mol % of the monofunctional water soluble monomer, wherein the first type of mucin-binding unit comprises of 1 unit up to 50% of the first branched or hyperbranched water-soluble polymer based on molecular weight, wherein the first type of mucin-binding unit is functionalized so the first branched or hyperbranched water-soluble polymer has the characteristic of altering the hydration, rheology, or both of a mucin polymer, a second water-soluble polymer, or a combination thereof, wherein altering the hydration, rheology, or both is achieved through mucoadhesion, mucolability, mucointegration, or a combination thereof.

The present disclosure provides for a composition, comprising a first branched or hyperbranched water-soluble polymer having a molecular weight of about 10 kDa to 10,000 kDa, wherein the first branched or hyperbranched water-soluble polymer includes a plurality of backbone units and at least one first type of a mucin-binding unit, wherein the backbone units comprise greater than 50% of the first branched or hyperbranched water-soluble polymer based on molecular weight, wherein the backbone unit is a reaction product of a first inimer and a second inimer, wherein the first inimer and the second inimer contain a vinyl group and a group capable of initiating polymerization or capable of being transformed into a group capable of initiating polymerization, wherein the first type of mucin-binding unit comprises of 1 unit up to 50% of the first branched or hyperbranched water-soluble polymer based on molecular weight, wherein the first type of mucin-binding unit is functionalized so the first branched or hyperbranched water-soluble polymer has the characteristic of altering the hydration, rheology, or both of a mucin polymer, a second water-soluble polymer, or a combination thereof, wherein altering the hydration, rheology, or both is achieved through mucoadhesion, mucolability, mucointegration, or a combination thereof.

The present disclosure provides for a composition, comprising a first water-soluble polymer having a molecular weight of about 10 kDa to 10,000 kDa, wherein the first water-soluble polymer includes a plurality of backbone units and at least one first type of a mucin-binding unit, wherein the backbone units comprise greater than 50% of the first water-soluble polymer based on molecular weight, wherein the first type of mucin-binding unit comprises of 1 unit up to 50% of the first water-soluble polymer based on molecular weight, wherein the first type of mucin-binding unit is functionalized so the first water-soluble polymer has the characteristic of altering the hydration, rheology, or both of a mucin polymer, a second water-soluble polymer, or a combination thereof, wherein altering the hydration, rheology, or both is achieved through mucoadhesion, mucolability, mucointegration, or a combination thereof; wherein the backbone unit comprises monomer units and copolymers including the monomer units, wherein the monomer unit is selected from the group consisting of: a substituted acrylamide or a substituted methacrylamide, or wherein the mucin-binding unit comprises monomer units or copolymers that include the monomer units, wherein the monomer unit is selected from the group consisting of: (4-((2-acrylamidoethyl)carbamoyl)-3-chlorophenyl)boronic acid), (4-((2-acrylamidoethyl)carbamoyl)-3-fluorophenyl)boronic acid), (4-((2-acrylamidoethyl)carbamoyl)-3-bromophenyl)boronic acid), (4-((2-acrylamidoethyl)carbamoyl)-3-iodophenyl)boronic acid)), a monomer including one or more boronic acid groups, a monomer containing one or more disulfide-forming groups, or a derivative of any one of these, wherein the backbone unit is N-hydroxyethyl acrylamide having the following structure:

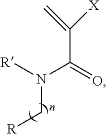

wherein n is 1 to 10, wherein R is a hydroxy group, an amine group, a carboxylate group, or a sulfonate group, wherein R′ is a C1 to C18 linear or branch alkyl group.

### BRIEF DESCRIPTION OF THE DRAWINGS

The present disclosure may be better understood with reference to the following figures.

FIG. 1.1A illustrates a photoiniferter polymerization scheme of DMA using iniferter 1 under inverse miniemulsion conditions. FIG. 1.1B illustrates a representation of the inverse miniemulsion polymerization components.

FIG. 10 illustrates Scheme A and B. Scheme A illustrates the photolytic bond cleavage of a generic photoiniferter (ZC(═S)SR). Scheme B illustrates a photoiniferter polymerization of N, N-dimethylacrylamide (DMA) using 2-(ethylthiocarbonothioylthio)propanoic acid (iniferter 1) to produce poly(N,N-dimethylacrylamide) (PDMA).

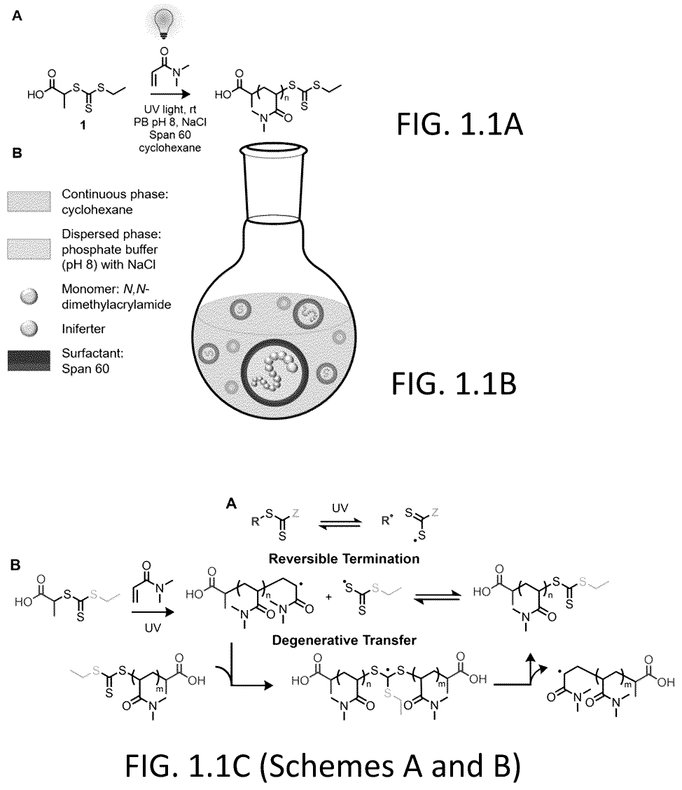

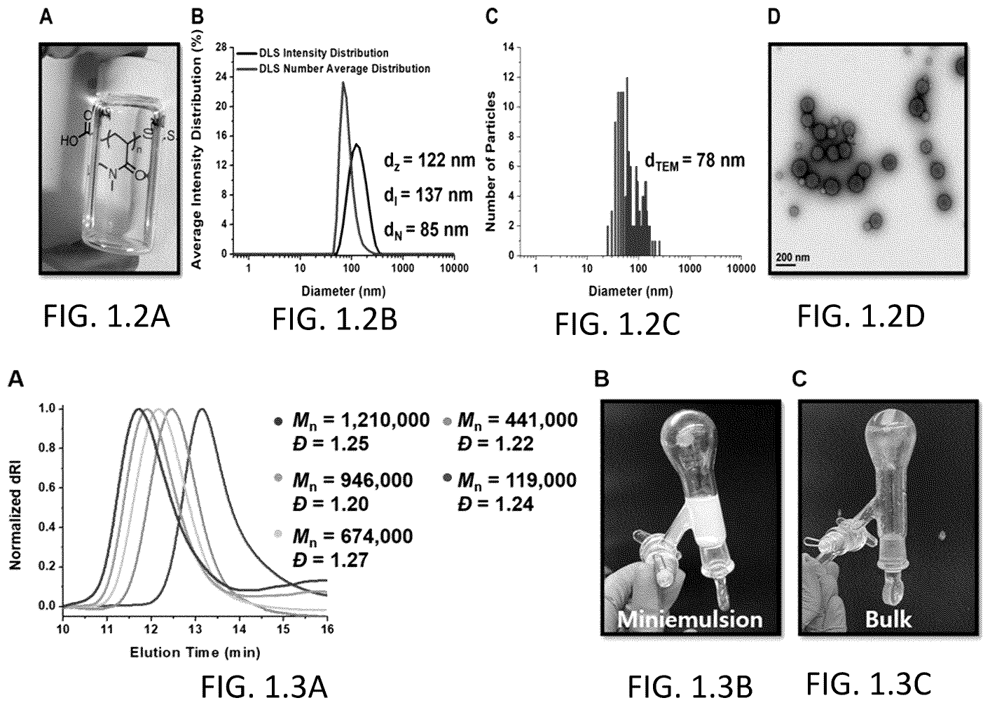

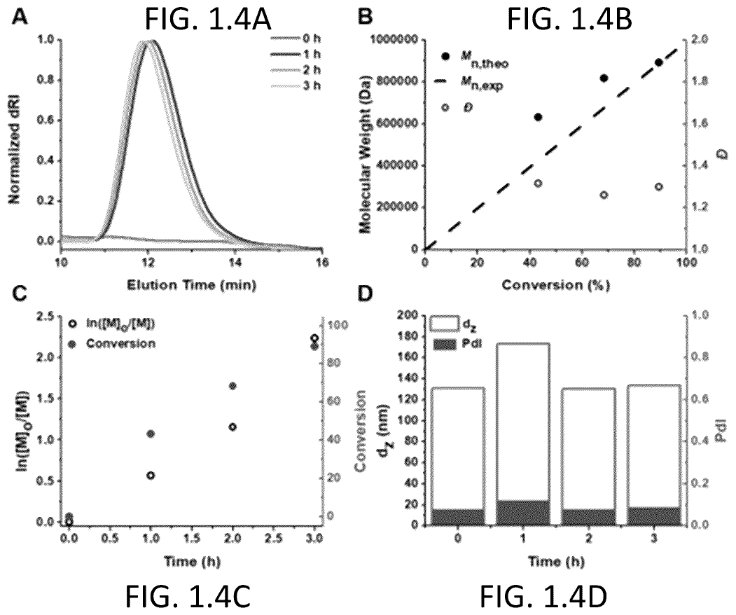

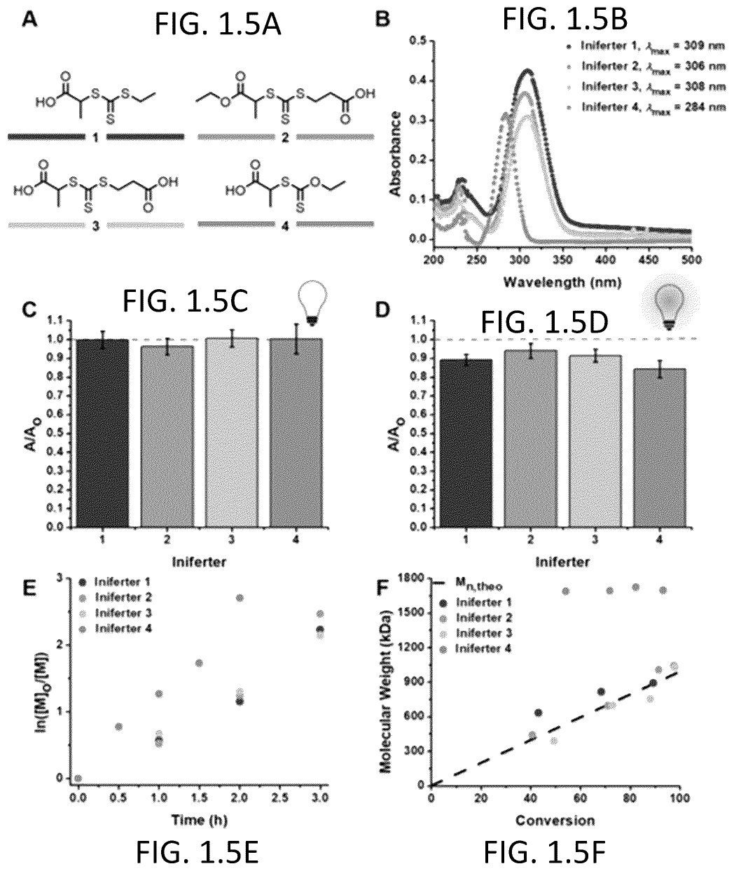

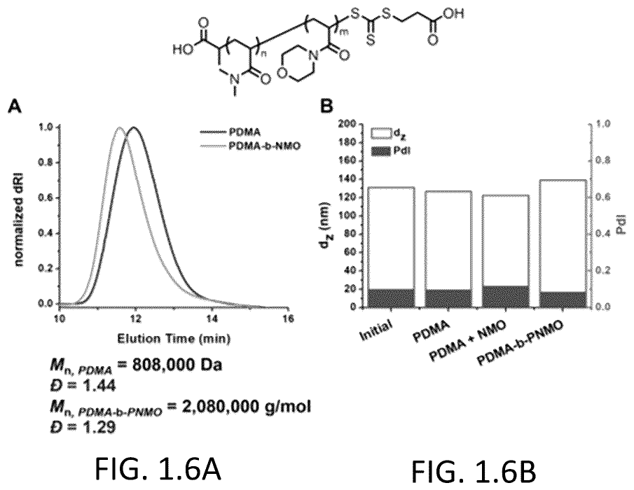

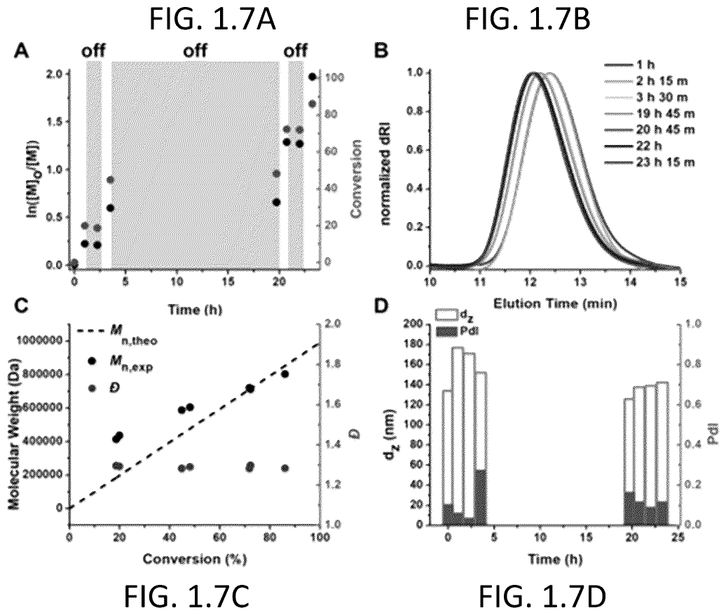

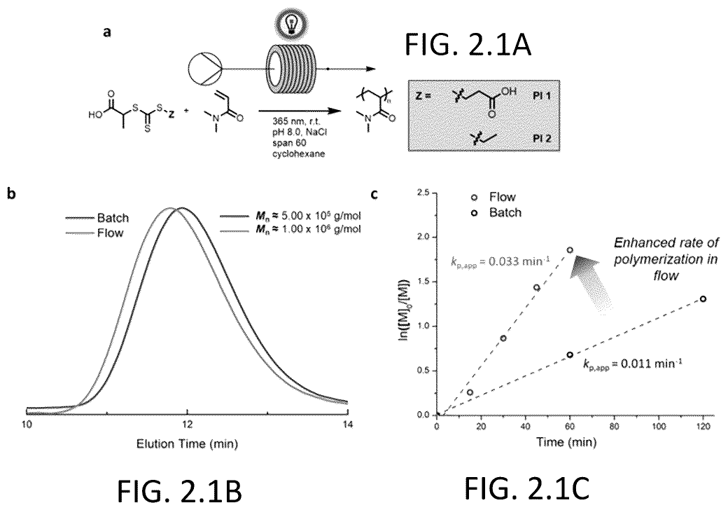

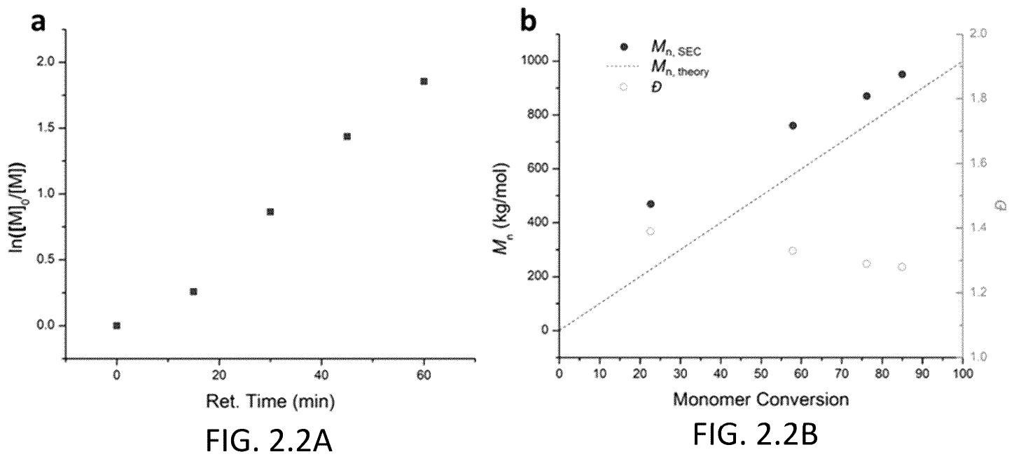

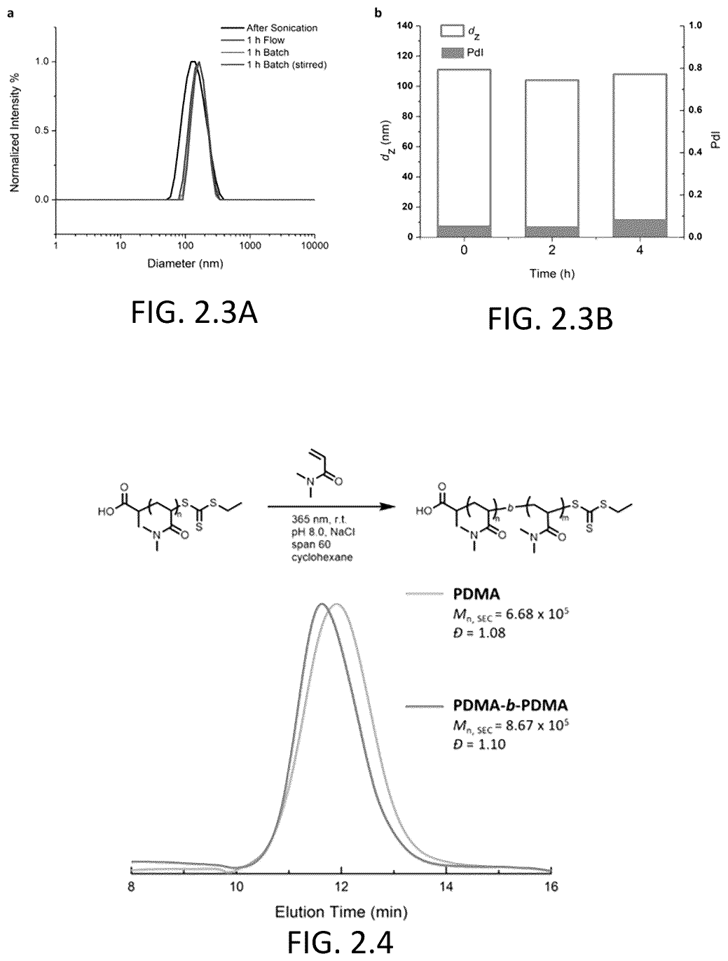

FIG. 1.2A illustrates a photo of an emulsion formulated as described in Table 1 taken after sonication and prior to polymerization. FIG. 1.2B illustrates DLS size distributions showing the number-average (d_{N}), intensity-average (d_{I}), and z-average (d_{z}) hydrodynamic diameter of the particles after polymerization in the presence of MBA as a crosslinker. FIG. 1.2C illustrates the size distribution of crosslinked PDMA particles (n=133) from TEM images. FIG. 1.2D) TEM image of PDMA particles with MBA crosslinker.

FIG. 1.3A illustrates SEC traces of PDMA prepared by inverse miniemulsion photoiniferter polymerization with molecular weights ranging from 119,000 to 1,210,000 Da. Polymer reaching a molecular weight of 1,210,000 Da (red trace) was accessible by reducing the polymerization temperature to 10° C. FIG. 1.3B illustrates a photo of a post-polymerization DMA miniemulsion system in a 10-mL Schlenk flask. Upon inversion, the solution readily flows. FIG. 1.3C illustrates a photo of a post-polymerization DMA polymerization in homogeneous aqueous media (5 M DMA in PB) in a 10-mL Schlenk flask. Upon inversion, the high-viscosity solution flows very slowly.

FIG. 1.4A illustrates SEC traces of DMA polymerization mediated by iniferter 1 with conditions as listed in Table 1, showing a shift to lower elution times with increased polymerization time. FIG. 1.4B illustrates experimental and theoretical number-average molecular weight (Mₙ) and molar mass dispersity as a function of monomer conversion. FIG. 1.4C illustrates linear pseudo-first-order kinetic plot, indicating a constant radical flux in the system. FIG. 1.4D illustrates particle diameter (d_{z}) plotted as a function of polymerization time.

FIG. 1.5A illustrates structures of iniferters 1-4. FIG. 1.5B illustrates UV-vis absorbance spectra and λₘₐₓ absorbance of iniferters 1-4. FIG. 1.5C illustrates change in UV absorbance of iniferters 1-4 in PB before and after the addition of cyclohexane without UV light. FIG. 1.5D illustrates change in the UV absorbance of iniferters 1-4 in PB after UV irradiation. FIG. 1.5E illustrates pseudo-first-order kinetic plots and FIG. 1.5F illustrates experimental molecular weight (Mₙ) plotted as a function of monomer conversion for polymerizations carried out using iniferters 1-4.

FIG. 1.6A illustrates SEC traces of PDMA and PDMA-b-PNMO mediated by iniferter 3 under the conditions indicated in Table 1. PDMA prepared by inverse miniemulsion polymerization (M_{n,exp}=808,000 Da, M_{n,theo}=880,000 Da, Ð=1.44) was chain extended with NMO to a final conversion-99% conversion in 4 h (M_{n,exp}=2,080,000, M_{n,theo}=2,480,000, ♦=1.29). FIG. 1.6B illustrates Z-average particle diameters (d_{z}) before the initial polymerization, after DMA polymerization, after the NMO/PB solution was added to the PDMA miniemulsion, and after PDMA-b-NMO synthesis.

FIG. 1.7A-D illustrate temporal control studies of DMA polymerization using iniferter 1 under the inverse miniemulsion conditions of Table 1. FIG. 1.7A illustrates pseudo-first-order kinetic plot and monomer conversion with time during on-off light cycles. FIG. 1.7B illustrates SEC traces showing that molecular weight increases with increasing monomer conversion. FIG. 1.7C illustrates experimental molecular weight and dispersity plotted as a function of monomer conversion. M_{n,exp} increases linearly with monomer conversion and dispersities remain reasonable throughout the polymerization. FIG. 1.7D illustrates particle size plotted as a function of polymerization time throughout the on-off light cycles.

FIG. 2.1A illustrates inverse miniemulsion photoiniferter polymerization of N,N-dimethylacrylamide (DMA) in continuous flow. FIG. 2.1B illustrates gel permeation chromatography traces of batch and flow photoiniferter polymerizations of DMA where [DMA]:[photoiniferter]=10,000:1 (5 M monomer concentration, 1 h irradiation). FIG. 2.1C illustrates pseudo-first-order kinetic rate plot of batch and flow polymerizations. Polymerizations conducted in flow exhibit enhanced apparent propagation rate constants (k_{p,app}).

FIGS. 2.2A-B illustrate inverse miniemulsion photoiniferter polymerization of N,N-dimethylacrylamide (DMA) in continuous flow, where FIG. 2.2A illustrates linear pseudo-first-order-kinetics and FIG. 2.2B illustrates number-average molecular weight (Mₙ) versus conversion from a continuous-flow inverse miniemulsion photoiniferter polymerization of DMA with PI 1 targeting Mₙ=1,000,000 g/mol at complete conversion. Linearity in the kinetic plot, increasing molecular weight with conversion, and relatively low D values are indicative of controlled polymerization.

FIGS. 2.3A-B illustrate dynamic light scattering results, where FIG. 2.3A illustrates particle size before and after incubation (1 h) in various batch and flow reactors without UV exposure and FIG. 2.3B illustrate particle size before polymerization and sample collected after two and four retention times (1 h). The final polymer particle sizes are comparable.

FIG. 2.4 illustrates GPC traces of PDMA and PDMA-b-PDMA mediated by PI 2. PDMA was prepared in inverse mini emulsion conditions in continuous flow was chain-extended with DMA yielding PDMA-b-PDMA. The void volume of this GPC system was 10 mL.

### DETAILED DESCRIPTION

### Definitions

For convenience, before further description of the present invention, certain terms used in the specification, examples and appended claims are collected here. It is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims. These definitions should be read in light of the remainder of the disclosure and understood as by a person of skill in the art. Unless defined otherwise, all technical and scientific terms used herein have the same meaning as commonly understood by a person of ordinary skill in the art. The terms used throughout this specification are defined as follows, unless otherwise limited in specific instances.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, biochemistry, molecular biology, genetics, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

The articles “a,” “an” and “the” are used to refer to one or to more than one (i.e., to at least one) of the grammatical object of the article.

As used herein, “about,” “approximately,” and the like, when used in connection with a numerical variable, generally refers to the value of the variable and to all values of the variable that are within the experimental error (e.g., within the 95% confidence interval for the mean) or within +/−10% of the indicated value, whichever is greater.

The terms “comprise”, “comprising”, “including” “containing”, “characterized by”, and grammatical equivalents thereof are used in the inclusive, open sense, meaning that additional elements may be included. It is not intended to be construed as “consists of only.”

As used herein, “subject” refers to any living entity comprised of at least one cell. A living organism can be as simple as, for example, a single isolated eukaryotic cell or cultured cell or cell line, or as complex as a mammal, including a human being, and animals (e.g., vertebrates, amphibians, fish, mammals, e.g., cats, dogs, horses, pigs, cows, sheep, rodents, rabbits, squirrels, bears, primates (e.g., chimpanzees, gorillas, and humans).

As used herein, the terms “treating” and “treatment” can refer generally to obtaining a desired pharmacological and/or physiological effect. The effect can be, but does not necessarily have to be, prophylactic in terms of preventing or partially preventing a disease, symptom or condition thereof. The effect can be therapeutic in terms of a partial or complete cure of a disease, condition, symptom or adverse effect attributed to the disease, disorder, or condition. The term “treatment” as used herein can include any one or more of the following: (a) preventing the disease from occurring in a subject which may be predisposed to the disease but has not yet been diagnosed as having it; (b) inhibiting the disease, i.e., arresting its development; and (c) relieving the disease, i.e., mitigating or ameliorating the disease and/or its symptoms or conditions. The term “treatment” as used herein can refer to both therapeutic treatment alone, prophylactic treatment alone, or both therapeutic and prophylactic treatment. Those in need of treatment (subjects in need thereof) can include those already with the disorder and/or those in which the disorder is to be prevented. As used herein, the term “treating”, can include inhibiting the disease, disorder or condition, e.g., impeding its progress; and relieving the disease, disorder, or condition, e.g., causing regression of the disease, disorder and/or condition. Treating the disease, disorder, or condition can include ameliorating at least one symptom of the particular disease, disorder, or condition, even if the underlying pathophysiology is not affected, such as treating the pain of a subject by administration of an analgesic agent even though such agent does not treat the cause of the pain.

As used herein, “preventative” and “prevent” refers to hindering or stopping a disease or condition before it occurs, even if undiagnosed, or while the disease or condition is still in the sub-clinical phase.

“Polymers” are understood to include, but are not limited to, homopolymers, copolymers, such as for example, block, graft, random and alternating copolymers, terpolymers, etc. and blends and modifications thereof.

As used herein, the term “disease” refers to an interruption, cessation, or disorder of body function, systems, or organs.

As used herein, “derivative” refers to a chemical compound or molecule made from a parent compound by one or more chemical reactions.

### DISCUSSION

The present disclosure provides for compositions including at least one type of water-soluble polymer having a molecular weight of about 10 kDa to 10,000 kDa, methods of making the water-soluble polymer, structures having the water-soluble polymer disposed thereof, and methods of use thereof. The present disclosure provides for branched and hyperbranched water-soluble polymers and methods of making branched and hyperbranched water-soluble polymers.

In an aspect, the present disclosure provides for methods for the synthesis of one or more types of water-soluble polymer, such as those provided herein. The water-soluble polymers can have a molecular weight of about 10 kDa to 10,000 kDa prepared. The methods can be prepared via a heterogeneous inverse miniemulsion system, methods of emulsion preparation and dispersion, and methods of polymerization in batch and flow reactor conditions. The chemical identity of the emulsion continuous phase, dispersed phase, surfactant, stabilizer, monomer, initiator structures and resultant water-soluble polymer are provided herein and/or can be determined.

In an aspect, the heterogeneous inverse miniemulsion processes have one or more of the following characteristics: (1) the ability to prepare high molecular weight water-compatible polymers in a low viscosity, high solid form; (2) formation of water-in-oil emulsion of an aqueous solution of vinyl monomers in an inert hydrocarbon liquid organic dispersion medium; (3) formation of droplet particle size in the range of 50 to 500 nm; (4) radically polymerizing said monomers in said dispersion medium to form polymeric droplets.

The present disclosure provides for water-soluble polymers having high molecular weights, and application of the water-soluble polymer for gelation and restoration of the functional biological properties of mucinated networks and surfaces. Embodiments of the water-soluble polymer can have one or more of the following characteristics: (1) Mucoadhesion: capable of forming covalent or non-covalent interactions (e.g., non-covalent interactions can be described as supramolecular interactions including, but not limited to, hydrogen bonding, ionic bonds, van Der Waals interactions, hydrophobic interactions, and macromolecular chain entanglement) with naturally occurring mucins; (2) Mucolability: the interactions between the water-soluble polymers and the mucins should typically be reversible, such that these interactions are reversed by mechanical force, background hydrolysis, redox reactions, or exchange with other interactions; and (3) Muco-integration: because of their ability to form interactions with natural mucins and because of their similar degrees of hydrophilicity to natural mucins, the water-soluble polymer are capable of integrating into mucin networks and/or interacting with membrane-bound mucins. The combination of these three characteristics allows the materials described in this invention to augment the hydration and rheology of mucinated surfaces in vivo. The water-soluble polymers of the present disclosure are designed to interact weakly with mucins, either via rapidly reversible interactions or by forming only a minimal number of interactions with mucins.

The water-soluble polymer of the present disclosure can be synthesized from the polymerization of hydrophilic monomers, yielding highly water-soluble polymers. In an aspect, the water-soluble polymer can have overall molecular weight of about 10 kDa to 10,000 kDa or about 100 kDa to 10,000 kDa. The majority (e.g., greater than 50% or about 75 to 99.9 weight percent) of the molecular weight of these polymers is derived from inert, hydrophilic functionality in the backbone (e.g., N,N-dimethylacrylamide). The functionalities and/or structure (e.g., linear or non-linear) of the monomers and/or functional groups on monomers can be selected based on the ability to restore shear-thinning behavior of mucinous gels by forming weak, transient, reversible interactions with mucins and with one another. These transient interactions can be covalent (e.g., boronate ester formation, disulfide formation) or non-covalent (e.g., hydrogen bonding, calcium bridging via carboxylates). In other words, a portion of the units of the polymer are mucin-binding units. In an example, these interactions can be accomplished through polymers comprised of N,N-dimethylacrylamide, acrylic acid, 3-(acrylamide)phenylboronic acid, and pyridyl disulfide acrylamide, respectively. In addition, the water-soluble polymer of the present disclosure could also be composed of mixtures of hydrophobic and hydrophilic monomers (e.g., via polymerization of acrylates or styrenics and maleimides), provided the overall polymer was water-soluble. In an aspect, the functionalities (e.g., mucin-binding units such as monomers and/or functional groups) responsible for the transient interactions with mucins or between the water-soluble polymers of the present disclosure are typically sparsely distributed throughout the backbone to constitute 0.1% to 25% of the overall molecular weight of the water-soluble polymer. In an aspect, the low content of monomers/functional groups can be isolated in specific regions of the polymers, where the binding functionalities exist in gradient-type fashion along the polymer backbone or are isolated to regions primarily at one or both ends of the polymers (e.g., terminally located) or only in the middle region of the polymer (e.g., centrally located). In this way, the weight percent of the mucin-binding units can be from very low (e.g., 0.1 to 1 weight percent) to anywhere within the 0.1 to 25 weight percent of the overall molecular weight of the water-soluble polymer.

The term “water soluble” as in a “water-soluble polymer” is any polymer that is soluble in water at room temperature. Typically, a solution of a water-soluble polymer will transmit at least about 75%, more preferably at least about 95%, of light transmitted by the same solution after filtering. On a weight basis, a water-soluble polymer will preferably be at least about 35% (by weight) soluble in water, more preferably at least about 50% (by weight) soluble in water, still more preferably about 70% (by weight) soluble in water, and still more preferably about 85% (by weight) soluble in water. It is most preferred the water-soluble polymer is about 95% (by weight) soluble in water or completely soluble in water.

In one aspect, the present disclosure provides an ophthalmic solution including a water-soluble polymer. In one aspect, the present disclosure provides a method of treating or preventing a condition in an eye of a subject comprising administering a therapeutically effective amount of the ophthalmic solution disclosed herein to the eye, whereby the water-soluble polymer forms non-covalent interactions or reversible-covalent bonds with mucins or mucin-binding proteins. In another aspect, the water-soluble polymer can form a layer on a structure or device, where the device is used in mucin environments.

In an aspect, the composition includes a water-soluble polymer (e.g., linear or non-linear) having a molecular weight of about 100 kDa to 10,000 kDa. In an aspect, the composition can include other types of water-soluble polymers. It should be noted that in much of the discussion herein, reference is made to “first water-soluble polymer” but in compositions including two or more types of water-soluble polymers, the description provided herein for “first water-soluble polymer” equally applies to the other types of water-soluble polymers, where the two types of water-soluble polymers are chemically different.

The first water-soluble polymer includes a plurality of backbone units (e.g., linear or non-linear) and at least one first type of a mucin binding unit. The backbone units comprise greater than 50% or about 75 to 99.9% of the first water-soluble polymer based on molecular weight. The first type of mucin-binding unit comprises 1 unit up to 50% or about 0.1 to 25% of the first water-soluble polymer based on molecular weight. In other aspects, the first water-soluble polymer can include a second type or a third type of mucin-binding unit. Each type of mucin-binding unit can be 1 unit up to 25%, 1 functional unit to about 5%, about 0.1 to 25%, about 0.1 to 20%, about 0.1 to 15%, about 0.1 to 10%, about 0.1 to 5% or about 0.1 to 1% of the first water-soluble polymer based on molecular weight.

In an embodiment, the first water-soluble polymer can be linear or non-linear such as star-like, branched, hyperbranched, comb/brush-like, graph copolymer, bottle brush-like, or cyclic. In an aspect, the first water-soluble polymer can be a first branched water-soluble polymer or a hyperbranched first water-soluble polymer. In one embodiment, the first water-soluble polymer can be a polyelectrolyte, polyampholyte, or polyzwitterion.

A linear polymer can be defined as a macromolecular structure comprised of monomeric units covalently linked together in a sequential and unidirectional manner, forming a single continuous chain. This architecture is devoid of crosslinks, side chains and network structures that would arise from connections between polymer chains.

A branched polymer can be defined as a macromolecular architecture where one or more side chains extend from the primary linear backbone. For example, this architecture can result from the incorporation of monomers with multiple reactive sites during the polymerization process. These side chains, which may vary in length, regularity, and density create a more complex heterogeneous topology compared to linear polymers. The degree of branching (DB) can be calculated by the equation:

$$D B = \frac{2 D}{2 D + L}$$

where D represents molar equivalents of dendritic or branching unit, and L represents molar equivalents of the linear unit. Herein, branched polymers can be defined as having a DB greater than 0 but less than 0.4.

A hyperbranched polymer can be defined as a macromolecular structure characterized by tree-like topology that differentiates it from conventional branched polymers. The defining feature of hyperbranched polymers is their high DB, which is greater than 0.4 but less than 1.

In an aspect, the backbone unit can include monomer units and copolymers including the monomer units. In an aspect, the first water-soluble polymer can be a block copolymer, a random copolymer, a statistical copolymer, an alternating copolymer, or a gradient copolymer. In an aspect, the first water-soluble polymer is a block copolymer such as a AB diblock copolymer or a ABA triblock copolymer. Optionally the mucin binding unit is isolated on the A block of the AB diblock copolymer or A block of the ABA triblock copolymer. In an aspect, the A and B blocks of the AB or ABA block copolymers contain a mixture of comonomer units. In an aspect, the comonomer units within the A or B blocks can be arranged in alternating, random, statistical, or gradient fashion. In another aspect, one or more blocks of the copolymer can be water-insoluble as long as the overall copolymer is water-soluble. For example, one of A block or B block in a AB diblock copolymer or ABA triblock copolymer can be water-insoluble, where the copolymer itself is water-soluble.

A gradient copolymer is a polymer with more than one type of monomer unit where the frequency of occurrence of at least one monomer unit changes gradually along the polymer chain. A statistical copolymer is a copolymer in which the sequential distribution of the monomeric units obeys known statistical laws and is based on relative reactivities.

In an aspect, the monomer unit can be selected from: an acrylamide monomer, a methacrylamide monomer, an acrylate monomer, a methacrylate monomer, a styrenic monomer, a vinyl pyridine monomer, a maleimide monomer, a maleic anhydride-derived monomer, a vinyl ester monomer, a vinyl amide monomer, a vinyl halide monomer, or a derivative of anyone of these. In a particular aspect, the backbone unit can include a monomer unit or a copolymer including the monomer unit, where the monomer unit is selected from: acrylamide, N,N-dimethylacrylamide, N,N-dialkylacrylamides, N-alkylacrylamides, N,N-dialkyl methacrylamides, N-alkyl methacrylamides, alkyl methacrylates, alkyl acrylates, oligo(ethylene glycol) acrylate, oligo(ethylene glycol) methacrylate, oligo(ethylene glycol) acrylamide, or oligo(ethylene glycol) methacrylamide, a substituted acrylate (e.g., see below. the substitution (R) includes the functionality such as hydroxy group, amine group, carboxylate group, sulfonate group, and the like), a substituted methacrylate (e.g., see below, the substitution (R) includes the functionality such as hydroxy group, amine group, carboxylate group, sulfonate group, and the like) as well as a substituted acrylamide (e.g., see below, the substitution (R) includes the functionality such as hydroxy group, amine group, carboxylate group, sulfonate group, and the like), and a substituted methacrylamide (e.g., see below, the substitution (R) includes the functionality such as hydroxy group, amine group, carboxylate group, sulfonate group, and the like). In a specific aspect, the backbone unit is N,N-dimethylacrylamide. In another aspect, the backbone unit is N-hydroxyethyl acrylamide having the following structure (n is 1 to 10).

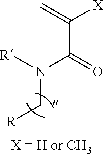

R = hydroxy group, amine group, carboxylate group, sulfonate group, and the like R′ = H or C₁-C₁₈ linear or branched alkyl n = 1-18 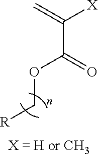
R = hydroxy group, amine group, carboxylate group, sulfonate group, and the like R′ = H or C₁-C₁₈ linear or branched alkyl n = 0-18

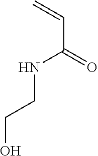

Each type (e.g., first type, second type, third type) of mucin-binding unit can be functionalized so the water-soluble polymer has the characteristic of altering the hydration, rheology, or both of a mucin-based polymer, a second water-soluble polymer, or a combination thereof. The characteristic of altering the hydration, rheology, or both can be achieved through mucoadhesion, mucolability, mucointegration, or a combination thereof, as described herein.

In an aspect, the mucin-binding unit can include a monomer unit or copolymers that include the monomer unit, where the monomer unit includes a functional group such as a boronic acid group, a carboxylate group, a carboxylic acid group, a hydrogen-bonding group, a hydrophobic group, or a group capable of forming disulfide linkages. In one embodiment, the plurality of functional groups is distributed in the first water-soluble polymer in homogenous, random, gradient, or blocky order and in a particular aspect, at a terminal end of the water-soluble polymer.

Each type of mucin-binding unit can be a monomer unit or segments of copolymers that include the monomer unit. The monomer unit can be selected from the group consisting of: acrylic acid, methacrylic acid, 4-vinylbenzoic acid, 4-(acrylamide)phenylboronic acid, 3-(acrylamide)phenylboronic acid, 2-(acrylamide)phenylboronic acid, 4-vinylphenylboronic acid, 3-vinylphenylboronic acid, 2-vinylphenylboronic acid, 2(4-((2-acrylamidoethyl)carbamoyl)-3-chlorophenyl)boronic acid), (4-((2-acrylamidoethyl)carbamoyl)-3-fluorophenyl)boronic acid), (4-((2-acrylamidoethyl)carbamoyl)-3-bromophenyl)boronic acid), (4-((2-acrylamidoethyl)carbamoyl)-3-iodophenyl)boronic acid), 2-(pyridin-2-yldisulfaneyl)ethyl methacrylate, pyridyl disulfide ethyl acrylate, pyridyl disulfide ethyl acrylamide, pyridyl disulfide alkyl (e.g. ethyl) methacrylamide, 2-(pyridin-2-yldisulfaneyl)ethyl acrylate, 2-(pyridin-2-yldisulfaneyl)ethyl acrylamide, 2-(pyridin-2-yldisulfaneyl)ethyl methacrylate, or 2-(pyridin-2-yldisulfaneyl)ethyl methacrylate, or a derivative of any one of these or copolymer of anyone of these or the following structure.

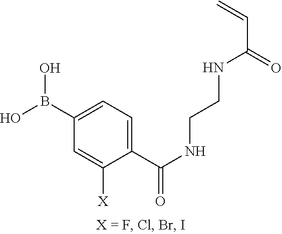

In an aspect, the first water-soluble polymer can have a chemical structure such as:

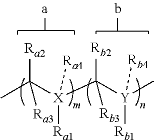

In an aspect, unit a is the backbone unit and m is greater than 50% or about 75 to 99.9% of the first water-soluble polymer based on molecular weight. In an aspect, m and n, independently on one another can be about 1000 to 100,000. Unit b is a first type of mucin-binding unit and n is 1 unit up to 50% or about 0.1 to 25% (or another range as provided herein) of the first water-soluble polymer based on molecular weight. Unit a and unit b are different from one another. The dashed lines for Rₐ₄ and R_{b4} indicated that this is optionally present based on X and Y, respectively.

In an aspect, Rₐ₁, Rₐ₂, Rₐ₃, Rₐ₄, R_{b1}, R_{b2}, R_{b3}, and R_{b4}, independently of one another, can be H, —OR₁, —NR₁R₂, —N⁺(R₁)₃, —N⁺(R₁)₂(R₂), —N⁺(R₁)(R₂)(R₃), —S(O)₂R₁, —S(O)₂OR₁, —S(O)₂NR₁R₂, —NR₁S(O)₂R₂, —NR₁C(O) R₂, —C(O)R₁, —C(O)OR₁, —C(O)NR₁R₂, —NR₁C(O)OR₂, —NR₁C(O)NR₁R₂, —OC(O)NR₁R₂, —NR₁S(O)₂NR₁R₂, —C(O)NR₁S(O)₂NR₁R₂, catechol, a boronic acid group, and a pyridyl disulfide group, where each R₁, R₂, and R₃ is independently H or linear or branched C₁₋₁₈ alkyl as well as —C(O)OCH₂CH₂—OH, —C(O)OCH₂CH₂—N(CH₃)₂, —C(O)OCH₂CH₂—N⁺(CH₃)₃, —C(O)OCH₂CH₂—OSO₃⁻, —C(O)OCH₂CH₂—OSO₃H, —C(O)OCH₂CH₂—SO₃⁻, —C(O)OCH₂CH₂—SO₃H, and —C(O)N(H)C((CH₃)₂)CH₂SO₃⁻, —C(O)N(H)C((CH₃)₂)CH₂SO₃H.

In an aspect, X can be N or C and Y can be C or N. In a particular aspect, X and Y are C.

In another aspect, the first water-soluble polymer has chemical structure such as:

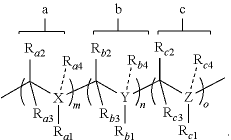

In an aspect, unit a can be the backbone unit and m is greater than 50% or about 75 to 99.9% of the first polymer based on molecular weight. In an aspect, m, n and o, independently on one another can be about 1000 to 100,000. Unit b can be a first type of mucin-binding unit and n is 1 unit up to 50% or about 0.1 to 24% (or another range as provided herein) of the first polymer based on molecular weight. Unit c is the second type of mucin binding unit and o is 1 unit up to 50% or about 0.1 to 24% (or another range as provided herein) of the first polymer based on molecular weight. Unit a and unit b are different from one another or unit a, unit b, and unit c are different than one another. The dashed lines for Rₐ₄, R_{b4}, and R_{c4} indicated that this is optionally present based X, Y, and Z, respectively. In an aspect, unit c can be responsible for mucin binding or can be responsible for further enhancing the hydrophilicity of the backbone (e.g., by introducing charge), for example.

In an aspect, Rₐ₁, Rₐ₂, Rₐ₃, Rₐ₄, R_{b1}, R_{b2}, R_{b3}, R_{b4}, R_{c1}, R_{c2}, R_{c3}, and R_{c4}, independently of one another, can be H, —OR₁, —NR₁R₂, —N⁺(R₁)₃, —N⁺(R₁)₂(R₂), —N⁺(R₁)(R₂)(R₃), —S(O)₂R₁, —S(O)₂OR₁, —S(O)₂NR₁R₂, —NR₁S(O)₂R₂, —NR₁C(O) R₂, —C(O)R₁, —C(O)OR₁, —C(O)NR₁R₂, —NR₁C(O)OR₂, —NR₁C(O)NR₁R₂, —OC(O)NR₁R₂, —NR₁S(O)₂NR₁R₂, —C(O)NR₁S(O)₂NR₁R₂, catechol, a boronic acid group, and a pyridyl disulfide group, where each R₁, R₂, and R₃ is independently H or linear or branched C₁₋₁₈ alkyl as well as —C(O)OCH₂CH₂—OH, —C(O)OCH₂CH₂—N(CH₃)₂, —C(O)OCH₂CH₂—N⁺(CH₃)₃, —C(O)OCH₂CH₂—OSO₃⁻, —C(O)OCH₂CH₂—OSO₃H, —C(O)OCH₂CH₂—SO₃⁻, —C(O)OCH₂CH₂—SO₃H, and —C(O)N(H)C((CH₃)₂)CH₂SO₃⁻, —C(O)N(H)C((CH₃)₂)CH₂SO₃H,

In an aspect, X can be N or C, where Y can be C or N and where Z can be N or C. In a particular aspect, X, Y, and Z are C.

In another aspect, the first water-soluble polymer has chemical structure such as:

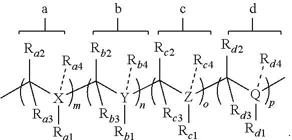

In an aspect, unit a can be the backbone unit and m is greater than 50% or about 75 to 99.9% of the first water-soluble polymer based on molecular weight. In an aspect, m, n and o, independently on one another can be about 1000 to 100,000. Unit b can be the first type of mucin-binding unit and n is 1 unit up to 50% or about 0.1 to 24% of the first polymer based on molecular weight. Unit c can be the second type of mucin-binding unit and o is about 0.1 to 24% of the first water-soluble polymer based on molecular weight. Unit d can be the third type of mucin-binding unit and o is 1 unit up to 50% or about 0.1 to 24% of the first water-soluble polymer based on molecular weight. Unit a and unit b can be different from one another, unit a, unit b, and unit c can be different than one another, or unit a, unit b, unit c, and unit d can be different than one another. The dashed lines for Rₐ₄, R_{b4}, R_{c4}, and R_{d4} indicated that this is optionally present based X, Y, Z, and Q respectively. In an aspect, unit c and/or unit d can be responsible for mucin binding or can be responsible for further enhancing the hydrophilicity of the backbone (e.g., by introducing charge), for example.

In an aspect, Rₐ₁, Rₐ₂, Rₐ₃, Rₐ₄, R_{b1}, R_{b2}, R_{b3}, R_{b4}, R_{c1}, R_{c2}, R_{c3}, R_{c4}, R_{d1}, R_{d2}, R_{d3}, and R_{d4}, independently of one another, can be H, —OR₁, —NR₁R₂, —N⁺(R₁)₃, —N⁺(R₁)₂(R₂), —N⁺(R₁)(R₂)(R₃), —S(O)₂R₁, —S(O)₂OR₁, —S(O)₂NR₁R₂, —NR₁S(O)₂R₂, —NR₁C(O) R₂, —C(O)R₁, —C(O)OR₁, —C(O)NR₁R₂, —NR₁C(O)OR₂, —NR₁C(O)NR₁R₂, —OC(O)NR₁R₂, —NR₁S(O)₂NR₁R₂, —C(O)NR₁S(O)₂NR₁R₂, catechol, a boronic acid group, and a pyridyl disulfide group, where each R₁, R₂, and R₃ is independently H or linear or branched C₁₋₁₈ alkyl as well as —C(O)OCH₂CH₂—OH, —C(O)OCH₂CH₂—N(CH₃)₂, —C(O)OCH₂CH₂—N⁺(CH₃)₃, —C(O)OCH₂CH₂—OSO₃⁻, —C(O)OCH₂CH₂—OSO₃H, —C(O)OCH₂CH₂—SO₃⁻, —C(O)OCH₂CH₂—SO₃H, and —C(O)N(H)C((CH₃)₂)CH₂SO₃⁻, —C(O)N(H)C((CH₃)₂)CH₂SO₃H,

In an aspect, X can be N or C, where Y can be C or N, where Z can be N or C, and where Q can be N or C. In a particular aspect, X, Y, Z and Q are C.

In one aspect, the water-soluble polymer of the present disclosure can be prepared via aqueous reversible-deactivation radical polymerization (See, Chem, 2017, 2(1), 93-101). In one embodiment, the polymeric material is prepared via macromolecular design by interchange of xanthate (MADIX) polymerization. In one embodiment, the polymeric material is prepared via photoiniferter polymerization. These materials with controlled molecular weight could also be derived through other controlled radical polymerization methods, such as atom transfer radical polymerization, and nitroxide mediated polymerization. Additionally, these materials could be derived through conventional radical, anionic, cationic, ring-opening, and ring-opening metathesis polymerization.

In particular, the present disclosure provides for synthetic methods of making the first water-soluble polymer as provided herein by polymerizing a backbone unit (e.g., linear or non-linear) and at least one mucin-binding unit to form the first water-soluble polymer. The polymerization can be a radical polymerization, conventional radical polymerization, reversible-deactivation radical polymerization, reversible addition-fragmentation chain transfer (RAFT) polymerization, macromolecular design by interchange of xanthate (MADIX) polymerization, photoiniferter polymerization, atom transfer radical polymerization (ATRP), or stable free radical polymerization (SFRP).

A typical photoiniferter polymerization initiated by a trithiocarbonate is as follows. targeting Mₙ≥5.00×10⁶ g/mol). DMA (394 mg, 3.97 mmol) and trithiocarbonate iniferter (20.0 g, 7.45×10⁵ mmol from 1.00 mg/mL dimethyl sulfoxide (DMSO) stock solution) were dissolved in water (1.70 mL, 2 M [DMA]) in a 10 mL Schlenk flask, and N,N-Dimethylformamide (DMF) (0.100 mL) was added as an internal standard. The iniferter stock solution was stored between 2 and 6° C. for further use. Argon was bubbled through the polymerization solution for 20 min. The reaction vessel was positioned 2.50 cm from the ultraviolet (UV) light source for an intensity of 7.0 mW/cm², and polymerization was initiated upon irradiation. Monomer conversion was determined by ¹H NMR spectroscopy, monitoring the disappearance of the DMA vinyl peaks (d, 1H, 5.60 ppm) relative to DMF (s, 1H, 8.02 ppm). Each reaction aliquot was dried by lyophilization and dissolved in SEC solvent (1 mg/mL) at least 24 h prior to molecular weight characterization.

An example chain extension polymerization that demonstrates the ability to make high molecular weight block copolymers via photoiniferter polymerization is as follows. DMA (417 mg, 4.20 mmol) and trithiocarbonate iniferter (0.100 mg, 3.72×10⁻⁴ mmol from 1.00 mg/mL DMSO stock solution) were dissolved in water (3.70 mL 1 M [DMA]) in a 10 mL Schlenk flask and DMF (0.100 mL) was added as an internal standard. Argon was bubbled through the polymerization solution for 20 min. The reaction vessel was positioned 2.50 cm from the UV light source for an intensity of 7.0 mW/cm² and polymerization was initiated upon irradiation. The reaction was irradiated for 24 h and a small amount was removed to determine monomer conversion via ¹H NMR spectroscopy by monitoring the disappearance of the vinyl, DMA peaks (d, 1 H, 5.60 ppm) relative to DMF (s, 1 H, 8.02 ppm) and to characterize molecular weight via SEC. The polymerization of the poly(DMA) (PDMA) first block reached >95% monomer conversion. DMA (420 mg, 4.24 mmol) was dissolved in water (3.10 mL), DMF (0.100 mL), and the preceding PDMA polymerization mixture. Argon was bubbled through the viscous solution for 20 min, and chain extension was initiated upon irradiation.

In an aspect, high mw (e.g., about 1,000,000 or according the mw as described herein) water soluble polymers made by inverse (water in oil) emersion photoiniferter polymerization. Mononers such as DMA, NVP and as well as other water soluble monomers including all of those described herein would lend themselves well to these types of process. One goal is to make highly wettable surfaces on contacts and in ophthalmic formulations such as those described herein. Both batch and continuous flow systems are described herein and in the examples.

Now having described various aspects, additional details regarding the methods of making are provided. In an aspect, the present disclosure includes the synthesis of ultra-high molecular weight water-soluble polymers via photoiniferter polymerization under inverse miniemulsion conditions. The method can be a catalyst-free heterogeneous process that is mediated using low-intensity UV irradiation and offers rapid polymerization rates, excellent molecular weight control, high polymer end-group fidelity, temporal control, advanced architectures, and most notably, viscosity control. The polymerization conditions have been refine based on the type of the surfactant, costabilizer, and iniferter agent to achieve acrylamido homopolymers and block copolymers of molecular weights exceeding 1,000,000 Da at ambient temperature, as described herein and in the examples. This approach to well-defined ultrahigh molecular weight polymers can overcome one or more of the complications of high viscosity to facilitate eventual scale-up. This process can be conducted, for example, under batch or continuous flow conditions. The methods using heterogeneous inverse miniemulsion processes have at least one of the following characteristics: (1) the ability to prepare high molecular weight water-compatible polymers in a low viscosity, high solid form; (2) formation of water-in-oil emulsion of an aqueous solution of vinyl monomers in an inert hydrocarbon liquid organic dispersion medium; (3) formation of droplet particle size in the range of 50 to 500 nm; (4) radically polymerizing said monomers in said dispersion medium to form polymeric droplets.

In a specific embodiment, the first water-soluble polymer can be non-linear such as branched or hyperbranched hydrocarbon. The polymerization can be a radical polymerization, conventional radical polymerization, self condensing vinyl polymerization (SCVP), reversible-deactivation radical polymerization, reversible addition-fragmentation chain transfer (RAFT) polymerization, macromolecular design by interchange of xanthate (MADIX) polymerization, iniferter polymerization, atom transfer radical polymerization (ATRP), or stable free radical polymerization (SFRP).

To achieve a branching structure, a monofunctional (i.e., containing one vinyl or functional group capable undergoing linear polymerization) water soluble (e.g., N,N-dimethyl acrylamide (DMA), N-hydroxyethyl acrylamide (HEAm), 2-methacryloyloxyethyl phosphorylcholine (MPC), acrylic acid (AA) and the like, monomer or any mixture of water soluble monomers can be copolymerized with a multifunctional (i.e., containing two or more vinyl or other functional groups capable of undergoing radical polymerization) water soluble monomer (e.g., N,N′-methylenebisacrylamide, poly(ethylene glycol) dimethacrylate, poly(ethylene glycol) diacrylate), poly(ethylene glycol) diacrylamide, N-[tris-(3-acrylamidopropoxymethyl)-methyl]acrylamide, and the like. Herein, a vinyl group is defined as bring derived from the functional group H₂C═CHR, and yields an extended alkane chain (—CH₂—CHR)ₙ upon polymerization.

The branched and hyperbranched polymers obtained by these methods can have molecular weights from 10 kDa to 10,000 kDa. To achieve these molecular weights without macroscopic gelation, the multifunctional monomer must be incorporated at low mol % (<1% relative to monofunctional monomer) ratios relative to monofunctional monomer. The degree of branching of polymers prepared with this method are greater than 0, but less than 0.4.

The following schematic illustrates the formation of branched polymer.

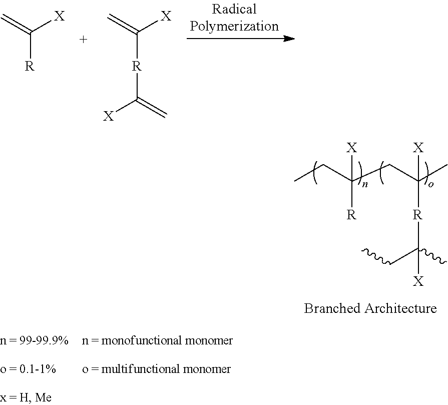

Branched polymers were prepared as follows: a 1000 mL reaction volume polymerization was conducted at a solid content of 5% in DMSO/water 15/85 w/w %. After addition of monofunctional monomers into DMSO, water is added and allowed to stir until fully dissolved. This solution is transferred to a reactor, where the multifunctional monomer and radical initiator are added sequentially. The solution is purged at 150 mL/min with nitrogen for 25 minutes and subsequently at 40 mL/min to maintain nitrogen atmosphere. A typical reaction utilizes less than or equal to 0.15 mol % multifunctional monomer and 0.25 mol % radical initiator relative to monofunctional monomer. The temperature schedule for a typical reaction follows: 16-56° C. heating ramp, 2 hours; 56° C. hold, 10 hours; 56-16° C. cooling ramp, 2 hours.

In another embodiment, self-condensing vinyl polymerization (SCVP) can be used to synthesize hyperbranched polymers through the polymerization of inimers (i.e., a molecule containing a vinyl group and a group capable of initiating polymerization or capable of being transformed into a group capable of initiating polymerization, such as thiocarbonylthio groups for RAFT polymerization or halogens for ATRP). Polymerization through reaction of the vinyl group, and resulting oligomers are linked in a step growth fashion through reaction of the pendent initiating center on the inimer, creating highly branched architectures. Herein, a vinyl group is defined as bring derived from the functional group H₂C═CHR, and yields an extended alkane chain (—CH₂—CHR)n upon polymerization. In the reaction illustrated below X can be 1 to 20 carbons, 1 to 10 carbons, or 1 to 6 carbons (e.g., linear, branched, cyclic, aromatic, and combinations thereof) and includes the appropriate amount of hydrogens (e.g., —CH₂—, (—CH₂)_{n=1-20 or 1-10, or 1-6 or —CH3}) based on the position of the X consistent with carbon bonding.

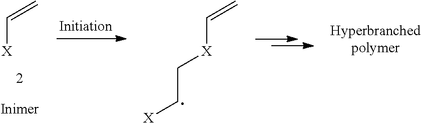

We have not synthesized these polymers via SCVP, but we have chosen to include it since it is a very common synthetic pathway to this polymer architecture.

Branched or hyperbranched polymers obtained by these methods have molecular weights from 10 kDa to 10,000 kDa. The polymers synthesized by SCVP have a degree of branching (DB) larger than 0.4 but less than 1. Polymers with a DB 0.01 to 0.4, known as segmented hyperbranched polymers, may also be synthesized by SCVP or other polymerization methods.

### Monomers:

In an aspect, the monomer unit can be one or more of: an acrylamide monomer, a methacrylamide monomer, an acrylate monomer, a methacrylate monomer, a styrenic monomer, a vinyl pyridine monomer, a maleimide monomer, a maleic anhydride-derived monomer, a vinyl ester monomer, a vinyl amide monomer, a vinyl halide monomer, a substituted acrylamide, a substituted methacrylamide, or a derivative of anyone of these. In a particular aspect, the backbone unit can include a monomer unit or a copolymer including the monomer unit, where the monomer unit one or more from: acrylamide, N,N-dimethylacrylamide, N,N-dialkylacrylamides, N-alkylacrylamides, N,N-dialkyl methacrylamides, N-alkyl methacrylamides, alkyl methacrylates, alkyl acrylates, oligo(ethylene glycol) acrylate, oligo(ethylene glycol) methacrylate, oligo(ethylene glycol) acrylamide, or oligo(ethylene glycol) methacrylamide, other substituted acrylates (e.g., the substitution (R) includes the functionality such as hydroxy group, amine group, carboxylate group, sulfonate group, and the like), other substituted methacrylates (e.g., the substitution (R) includes the functionality such as hydroxy group, amine group, carboxylate group, sulfonate group, and the like). In a specific aspect, the backbone unit is N,N-dimethylacrylamide.

In another aspect, the backbone unit is N-hydroxyethyl acrylamide having the following structure (n is 1 to 10).

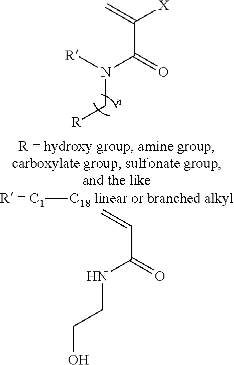

### Photoiniferter/Initiator/Wavelength/Intensity:

In one aspect, photoiniferter polymerization can be used to synthesize high molecular weight polymers via an inverse mini emulsion process. An example of a photoiniferter refers to a photoinitiator, chain transfer and chain terminator agent with the chemical formula:

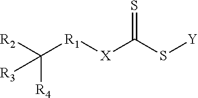

where R₁ is a divalent alkyl group of 1 to 12 carbon atoms, R₂ and R₃ are each independently hydrogen or alkyl group of 1 to 12 carbon atoms, and R₄ is —H, —OH or —COOH; where X represents —S,-0, or —NH; and where Y represents a functional group capable of activating radical addition across vinyl monomers. In an aspect, multiple photoiniferters may be chemically linked together via any of R₂, R₃, R₄, and/or Y.

In the photoiniferter polymerization, an irradiating step initiates the photopolymerization. The wavelength of irradiation commensurate with the photoinitiator used can be determined by ordinary skill in the art based on the chemistry used and the desired result. The wavelength can, for example, be in the visible spectrum or in the ultraviolet (UV) spectrum. Choice of wavelength depends on choice of initiator system since the initiator system can produce active centers upon absorption of a proper wavelength (likewise, choice of initiator system can be dependent on the desired wavelength of illumination as discussed above). The irradiation can be both temporal and spatial. The irradiation can determine temporal and spatial generation of active centers. The temporal irradiation can determine the time between initiation and termination of the polymerization. For example, the irradiation can be continuous or intermittent. The irradiation intensity can be tuned to affect the rate of radical generation.

In one embodiment, the polymeric material can be prepared via photoiniferter polymerization. These materials with controlled molecular weight could also be derived through other controlled radical polymerization methods, such as reversible addition-fragmentation chain transfer polymerization, atom transfer radical polymerization, and nitroxide mediated polymerization. Additionally, these materials could be derived through conventional radical, anionic, cationic, ring-opening, and ring-opening metathesis polymerization.

### Batch/Flow:

Inverse miniemulsion polymerization can be conducted in batch reactors or under continuous flow conditions in tubular reactors.

A batch reactor refers to a type of vessel in which a reaction is conducted and nothing is added or removed until the end of the reaction. In the context of this application, any batch reactor can be used such that light can be homogeneously distributed throughout the reaction solution. Miniemulsion droplets on the order of about 50-500 nm can be formed by ultrasonication prior to addition into the batch reactor or formed. Miniemulsion droplets in the size range of about 50 to 500 nm can be formed in continuous flow by the use of an in-line mixing device before being collected in a batch reactor and polymerized. The formed miniemulsion is subsequently irradiated in the batch reactor with a predefined wavelength and intensity to initiate polymerization. The temperature of the batch reactor is generally maintained at about 20° C. but polymerizations can be conducted at temperatures from about 7 to 70° C.

An embodiment of an inverse miniemulsion polymerization is as follows:

A general polymerization was carried out as follows: NaCl (60 mg, 1.0 mmol), phosphate buffer (PB, pH=8, 0.49 mL), DMA (500 mg, 5.0 mmol, 0.52 mL), iniferter 1 (10.6 μL from a 10 mg/mL solution in PB, 0.106 mg, 0.000504 mmol), DMF (100 μL), cyclohexane (10 g), and span 60 (150 mg, 0.35 mmol) were combined in a 20 mL vial. The DMA concentration was 5 M within the dispersed phase, and the [DMA]: [iniferter] ratio was 10,000:1. The aqueous phase (DMA, PB, DMF, and iniferter) was 9.3 wt % of the overall reaction. The continuous phase was cyclohexane (89 wt %). Span 60 comprised 1.3% of the overall reaction. NaCl was added at a concentration of 6 wt % relative to the DMA and PB.

Samples were sonicated for 15 min in a 20-mL vial using a sonicator probe (20% amplitude, 15 s on and 5 s off, % inch tip). Samples were transferred to a Schlenk flask at this point (if one was used), or the sample vial was capped with a septum. Samples were degassed with argon for 30 min (10-mL Schlenk) or 40 min (20-mL vial). The light source was switched on to initiate polymerization. A fan was used to cool the setup and keep the temperature at 30° C. A stir rate of 1,000 rpm was used throughout. Samples were analyzed using DLS, NMR, and SEC.

In an aspect, continuous flow or processing in a continuous mode refers to an uninterrupted sequence of operations, wherein a polymeric product is continuously received. A flow reactor contains at least: (1) one method of delivery of reactants to the reactor such as a syringe pump or peristaltic pump; (2) one inlet to a reactor; (3) one reactor chamber that contains a length of coiled flow tubes made of glass, fluorinated plastic tubing, or other suitable material with an constant interior diameter; (4) a reactor chamber that contains an irradiation source capable of initiating polymerization; and/or (5) one outlet where reactants exit the tubular reactor and the resultant polymers are collected. In another aspect, multiple flow reactors can be coupled together to synthesize block copolymers by in-line addition of monomer after the first reactor. The mixed solution is then subjected to irradiation in another reactor chamber to create a block copolymer.

In one aspect, miniemulsion droplets in the size range of about 50 to 500 nm can be formed in continuous flow by the use of an in-line mixing device. In another aspect, miniemulsion droplets can be formed by ultrasonication prior to addition into the continuous flow reactor. The formed miniemulsion is subsequently passed into a continuous tubular reactor and irradiated with a predefined wavelength and intensity to initiate polymerization. The temperature of the tubular reactor is generally maintained at about 20° C. but polymerizations can be conducted at temperatures from about 7 to 70° C.

An embodiment of the continuous flow reactor design:

A custom-made continuous flow reactor was built with easily-available lab materials. The top portion of a 1 L aluminum solvent drum was removed and holes for 1/16″ OD tubing were drilled into the side of the drum. The inside of the bottom portion was lined with a 5 m Waveform Lighting realUV LED strip. The measured output of the LED strip was 1.0 mW/cm². 6 ft of 1/16″ OD 0.03″ ID PTFE tubing (Darwin Microfluidics) was wrapped around an aluminum column and placed in the center of the reactor, yielding a reactor volume of 0.834 mL. The polymerization solution was delivered using a NE-300 syringe pump (New Era Pump Systems Inc.), and the syringe was coupled to the fluoropolymer tubing using PEEK ¼-28 flat-bottom fittings and ¼-28 female to female Luer lock adapter (IDEX Health & Science). A fan was placed on top of the reactor to maintain ambient temperature.

An embodiment of the continuous flow reaction:

A general polymerization was carried out as follows: NaCl (60 mg, 1.0 mmol), phosphate buffer (PB, pH=8, 0.49 mL), DMA (500 mg, 5.0 mmol, 0.52 mL), iniferter 1 (10.6 μL from a 10 mg/mL solution in PB, 0.106 mg, 0.000504 mmol), DMF (100 μL), cyclohexane (10 g), and span 60 (150 mg, 0.35 mmol) were combined in a 20 mL vial. The DMA concentration was 5 M within the dispersed phase, and the [DMA]: [iniferter] ratio was 10,000:1. The aqueous phase (DMA, PB, and DMF) was 11 wt % of the overall reaction. The continuous phase was cyclohexane (89 wt %). NaCl was added at a concentration of 6 wt % relative to the DMA and PB.

Samples were sonicated 15 min in a 20-mL vial using a sonicator probe (20% amplitude, 15 s on and 5 s off, % inch tip). The sample vial was capped with a septum. Samples were degassed with argon for 30 min. The solution was transferred to a 10 mL syringe and placed in the syringe pump. The solution was pumped at 13.9 μL/min to yield a total retention time of 1 h. Samples were collected as they exited the reactor tubing and were analyzed using DLS, NMR, and SEC.

### Different Mixing/Dispersion Methods:

Various techniques are available to prepare miniemulsion. In an aspect, the formation involves a single step or a series of consecutive steps, depending on the nature of the starting materials and methods used, as well as the type of desired emulsion. In general, the methods used to form conventional, nano/mini-, or even microemulsions can be divided into two categories: high-energy and low-energy methods, which can also be referred to as mechanical and chemical processes, respectively.¹ High-energy methods use mechanical devices, such as high pressure homogenizers, the microfluidizer, magnetic stirring, mechanical stirring, and fixed-bed mixers. These mechanical processes generate intense disruptive forces to break the dispersed phase up into smaller droplets. Low-energy methods to form nano/mini-emulsions include phase inversion methods, and rely on the spontaneous formation of droplets exploiting the system's chemical behaviors. Common low-energy methods to form nano/mini-emulsions include utility of phase inversion temperature (PIT) and phase inversion composition (PIC).² In an aspect, the method for forming a miniemulsion can include the following steps: providing a continuous phase; dispersing a stabilizer (i.e. surfactant) in said continuous phase; providing a second (dispersed) phase comprising monomer; and adding the second phase to the first phase in a manner adapted to form a miniemulsion through a dispersion method, where the miniemulsion comprises emulsified particles having a mean diameter of less than 1 μm, and wherein said emulsified particles are multilayered and/or spherical.

### Exemplary High-Energy Dispersion Methods:

Providing input of mechanical energy into a biphasic solution to generate emulsion droplets having a mean diameter at or below 1 μm, and wherein said emulsified particles are multilayered and/or spherical
   High pressure homogenizers
   Microfluidizer
   High-Shear stirring (magnetic and mechanical)
   Fixed-Bed Mixers

### Exemplary Low-Energy Methods

Manipulation of chemical properties of a biphasic solution (such as composition and/or temperature) to generate emulsion droplets having a mean diameter at or below 1 μm, and wherein said emulsified particles are multilayered and/or spherical
   Phase-Inversion Temperature Method^{a}
   Phase-Inversion Composition Method^{a}
   Bubble bursting at oil-water interface³
   Evaporative Ripening⁴
      The following is from “Nano-emulsions: Formation by low-energy methods” ⁵
      ^{a} These methods make use of the chemical energy released by phase transitions taking place during the emulsification process. Although these phase transitions often involve the inversion of the surfactant film curvature from positive to negative or vice versa, it has been shown that transitions from structures having a surfactant film with an average zero curvature (e.g. bicontinuous microemulsions or lamellar liquid crystalline phases) are those playing a key role in nano-emulsion formation. The phase transitions are triggered either by changing the temperature (Phase Inversion Temperature Method, PIT-based on the changes in the surfactant spontaneous curvature induced by temperature, or the composition (Phase Inversion Composition Methods, PIC). The PIT method can only be applied to surfactants sensitive to changes in temperature, i.e. polyoxyethylene-type nonionic surfactants in which changes in temperature induce a change in the hydration of the poly(oxyethylene) chains, and a consequent change of its curvature. In the PIC method, the phase transitions are induced by changes in the composition during emulsification, at constant temperature, and thus, it can be applied to surfactants other than ethoxylated-type.⁵
(1) Acosta, E. (2009). Bioavailability of nanoparticles in nutrient and nutraceutical delivery. Current Opinion in Colloid & Interface Science, 14(1), 3-15
(2) Wang, Y. (2014). Preparation of Nano- and Microemulsion using Phase Inversion and Emulsion Titration Methods.
(3) Roché, J., et al., Nanoemulsions obtained via bubble bursting at a compound interface. https://arxiv.org/ftp/arxiv/papers/1312/1312.3369.pdf
(4) Fryd, M., Mason, T., The Journal of Physical Chemistry Letters, Time-Dependent Nanoemulsion Droplet Size Reduction By Evaporative Ripening. 2010 1 (23), 3349-3353. 10.1021/jz101365h https://doi.org/10.1021/jz101365h
(5) Solans, C., et al., Nano-emulsions: Formation by low-energy methods. 10.1016/j.cocis.2012.07.003

### Emulsifiers:

There are two main actions of emulsifiers: reducing the interfacial tension between the phases, and forming a barrier between the phases. They can control the type of emulsion that is formed (oil in water: O/W, or water in oil: W/O). This can be indicated by an emulsifier's hydrophilic-lipophilic balance (HLB) number. An emulsifier and/or surfactant that has a low HLB number will form better W/O emulsion, whereas an emulsifier and/or surfactant that has a high HLB number will form better O/W emulsions. In many instances, a combination of emulsifiers/surfactants with high and low HLB numbers can be combined to give an optimum HLB of the system and most effectively reduce interfacial tension to give W/O or O/W droplets. Common emulsifiers include surfactants, which can be categorized as ionic or non-ionic.

| Surfactants | | Surfactants | |
|---|---|---|---|
| (non-ionic) | HLB | (ionic) | HLB |
| Brij 010 | 12.4 | Sodium oleate | 18 |
| SP Brij S2 MBAL | 4.9 | Potassium oleate | 20 |
| Brij S721 | 15.5 | Sodium bis(2- | 10.5 |
| | | ethylhexyl)sulfosuccinate | |
| Brij 30 | 9.5 | Sodium octadecanoate | 18 |
| Brij 35 | 16.9 | Sodium dodecanoate | 21 |
| Brij 52 | 5 | Sodium octanoate | 23 |
| Brij 58 | 16 | Sodium dodecyl sulfate | 40 |
| Brij 92 | 4 | | |
| Brij 93 | 4.9 | | |
| Brij 97 | 12 | | |
| Span 20 | 8.6 | | |
| Span 40 | 6.7 | | |
| Span 60 | 4.7 | | |
| Span 80 | 4.3 | | |
| Span 85 | 1.8 | | |
| Tween 20 | 16.7 | | |
| Tween 40 | 15.6 | | |
| Tween 60 | 14.9 | | |
| Tween 80 | 15 | | |
| Tween 85 | 11 | | |

The following provides aspects of the present disclosure.

The present disclosure provides for a synthetic method of making a first water-soluble polymer, comprising: polymerizing a backbone unit and at least one mucin-binding unit to form the first water-soluble polymer using photoiniferter polymerization under inverse miniemulsion conditions. The method is a catalyst-free heterogeneous process that is mediated using low-intensity UV irradiation. The method is a continuous process. The method is a batch flow process. The heterogeneous inverse miniemulsion process includes one of the following characteristics: (1) the ability to prepare high molecular weight water-compatible polymers in a low viscosity, high solid form; (2) formation of water-in-oil emulsion of an aqueous solution of vinyl monomers in an inert hydrocarbon liquid organic dispersion medium; (3) formation of droplet particle size in the range of 50 to 500 nm; or (4) radically polymerizing said monomers in said dispersion medium to form polymeric droplets. The first water-soluble polymer has a molecular weight of about 10 kDa to 10,000 kDa, wherein the first water-soluble polymer includes a plurality of backbone units and at least one first type of a mucin-binding unit, wherein the backbone units comprise greater than 50% of the first water-soluble polymer based on molecular weight, wherein the first type of mucin-binding unit comprises of 1 unit up to 50% of the first water-soluble polymer based on molecular weight, wherein the first type of mucin-binding unit is functionalized so the water-soluble polymer has the characteristic of altering the hydration, rheology, or both of a mucin polymer, a second water-soluble polymer, or a combination thereof, wherein altering the hydration, rheology, or both is achieved through mucoadhesion, mucolability, mucointegration, or a combination thereof. The backbone unit comprises monomer units and copolymers including the monomer units, wherein the monomer unit is selected from the group consisting of: an acrylamide monomer, a methacrylamide monomer, an acrylate monomer, a methacrylate monomer, a styrenic monomer, a vinyl pyridine monomer, a maleimide monomer, a maleic anhydride-derived monomer, a vinyl ester monomer, a vinyl ether monomer, a vinyl amide monomer, a vinyl amine monomer, a vinyl halide monomer, a substituted acrylamide, a substituted methacrylamide, or a derivative of anyone of these. The backbone unit comprises a monomer unit or a copolymer including the monomer unit, wherein the monomer unit is selected from the group consisting of: acrylamide, N,N-dimethylacrylamide, N,N-dialkylacrylamides, N-alkylacrylamides, N,N-dialkyl methacrylamides, N-alkyl methacrylamides, poly(ethlylene glycol) acrylate, poly(ethylene glycol) methacrylate, poly(ethylene glycol) acrylamide, and poly(ethylene glycol) methacrylamide. The backbone unit is N,N-dimethylacrylamide. The backbone unit is N-hydroxyethyl acrylamide having the following structure:

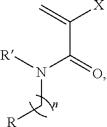

wherein n is 1 to 10, wherein R is a hydroxy group, an amine group, a carboxylate group, or a sulfonate group, wherein R′ is a C1 to C18 linear or branch alkyl group. The first water-soluble polymer has a structure that is linear or non-linear selected from the group consisting of star-like, branched, hyperbranched, cyclic, graph copolymer, or bottle brush-like. The first water-soluble polymer has a structure that is non-linear selected from the group consisting of branched or hyperbranched. The mucin-binding unit comprises monomer units or copolymers that include the monomer units, wherein the monomer unit is selected from the group consisting of: acrylic acid, methacrylic acid, 4-vinylbenzoic acid, 4-(acrylamide)phenylboronic acid, 3-(acrylamide)phenylboronic acid, 2-(acrylamide)phenylboronic acid, 4-vinylphenylboronic acid, 3-vinylphenylboronic acid, 2-vinylphenylboronic acid, 2-(pyridin-2-yldisulfaneyl)ethyl methacrylate, pyridyl disulfide ethyl acrylate, pyridyl disulfide ethyl acrylamide, pyridyl disulfide alkyl (e.g. ethyl) methacrylamide 2-(pyridin-2-yldisulfaneyl)ethyl acrylate, 2-(pyridin-2-yldisulfaneyl)ethyl acrylamide, 2-(pyridin-2-yldisulfaneyl)ethyl methacrylate, or 2-(pyridin-2-yldisulfaneyl)ethyl methacrylate, (4-((2-acrylamidoethyl)carbamoyl)-3-chlorophenyl)boronic acid), (4-((2-acrylamidoethyl)carbamoyl)-3-fluorophenyl)boronic acid), (4-((2-acrylamidoethyl)carbamoyl)-3-bromophenyl)boronic acid), (4-((2-acrylamidoethyl)carbamoyl)-3-iodophenyl)boronic acid), a monomer including one or more boronic acid groups, a monomer containing one or more disulfide-forming groups, or a derivative of any one of these. The mucin-binding unit comprises monomer units or copolymers that include the monomer units, wherein the monomer unit includes a functional group selected from the group consisting of: a boronic acid group, a carboxylate group, a carboxylic acid group, a hydrogen-bonding group, a hydrophobic group, a 1,2-diol group, a 1,3-diol group, a group capable of forming disulfide linkages or a derivative of any one of these. The first water-soluble polymer includes a second type of mucin-binding unit, wherein the second type of mucin-binding unit comprises monomer units or copolymers that include the monomer units, wherein the monomer unit is selected from the group consisting of: acrylic acid, methacrylic acid, 4-vinylbenzoic acid, 4-(acrylamide)phenylboronic acid, 3-(acrylamide)phenylboronic acid, 2-(acrylamide)phenylboronic acid, 4-vinylphenylboronic acid, 3-vinylphenylboronic acid, 2-vinylphenylboronic acid, 2-(pyridin-2-yldisulfaneyl)ethyl methacrylate, pyridyl disulfide ethyl acrylate, pyridyl disulfide ethyl acrylamide, pyridyl disulfide alkyl (e.g. ethyl) methacrylamide 2-(pyridin-2-yldisulfaneyl)ethyl acrylate, 2-(pyridin-2-yldisulfaneyl)ethyl acrylamide, 2-(pyridin-2-yldisulfaneyl)ethyl methacrylate, or 2-(pyridin-2-yldisulfaneyl)ethyl methacrylate, (4-((2-acrylamidoethyl)carbamoyl)-3-chlorophenyl)boronic acid), (4-((2-acrylamidoethyl)carbamoyl)-3-fluorophenyl)boronic acid), (4-((2-acrylamidoethyl)carbamoyl)-3-bromophenyl)boronic acid), (4-((2-acrylamidoethyl)carbamoyl)-3-iodophenyl)boronic acid), a monomer including one or more boronic acid groups, a monomer containing one or more disulfide-forming groups, or a derivative of any one of these, wherein the first type of mucin-binding unit is different than the second type of mucin-binding unit. The first water-soluble polymer includes a third type of mucin-binding unit, wherein the third type of mucin-binding unit comprises monomer units or copolymers that include the monomer units, wherein the monomer unit is selected from the group consisting of: acrylic acid, methacrylic acid, 4-vinylbenzoic acid, 4-(acrylamide)phenylboronic acid, 3-(acrylamide)phenylboronic acid, 2-(acrylamide)phenylboronic acid, 4-vinylphenylboronic acid, 3-vinylphenylboronic acid, 2-vinylphenylboronic acid, 2-(pyridin-2-yldisulfaneyl)ethyl methacrylate, pyridyl disulfide ethyl acrylate, pyridyl disulfide ethyl acrylamide, pyridyl disulfide alkyl methacrylamide, 2-(pyridin-2-yldisulfaneyl)ethyl acrylate, 2-(pyridin-2-yldisulfaneyl)ethyl acrylamide, 2-(pyridin-2-yldisulfaneyl)ethyl methacrylate, or 2-(pyridin-2-yldisulfaneyl)ethyl methacrylate, (4-((2-acrylamidoethyl)carbamoyl)-3-chlorophenyl)boronic acid), (4-((2-acrylamidoethyl)carbamoyl)-3-fluorophenyl)boronic acid), (4-((2-acrylamidoethyl)carbamoyl)-3-bromophenyl)boronic acid), (4-((2-acrylamidoethyl)carbamoyl)-3-iodophenyl)boronic acid), a monomer including one or more boronic acid groups, a monomer containing one or more disulfide-forming groups, or a derivative of any one of these, wherein the first type of mucin-binding unit is different than the second type of mucin-binding unit, wherein the second type of mucin-binding unit is different than the third type of mucin-binding unit monomer including one or more pyridyl disulfide groups, or a derivative of any one of these. The first type of mucin binding unit comprises 1 functional unit to about 5% of the first water-soluble polymer based on molecular weight; wherein the second type of mucin binding unit comprises 1 functional unit to about 5% of the first water-soluble polymer based on molecular weight; wherein the third type of mucin binding unit comprises 1 functional unit to about 5% of the first water-soluble polymer based on molecular weight. The first type of mucin binding unit is located solely at one or both terminal ends of the first water-soluble polymer. The first water-soluble polymer is a block copolymer. The first water-soluble polymer is a random copolymer. The first water-soluble polymer is a statistical copolymer. The first water-soluble polymer is an alternative copolymer. The first water-soluble polymer is a gradient copolymer. The block copolymer is an AB diblock copolymer or an ABA triblock copolymer, optionally wherein the mucin-binding units are isolated on the A block of the AB diblock copolymer or A block of the ABA triblock copolymer. The first water-soluble polymer has chemical structure as shown below:

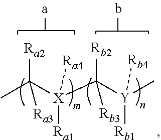

wherein unit a is the backbone unit and m is greater than 50% of the first water-soluble polymer based on molecular weight, wherein unit b is the first type of mucin binding unit and n is 1 unit to about 50% of the first water-soluble polymer based on molecular weight, wherein unit a and unit b are different from one another, Rₐ₁, Rₐ₂, Rₐ₃, Rₐ₄, R_{b1}, R_{b2}, R_{b3}, and R_{b4}, independently of one another, can be H, —OR₁, —NR₁R₂, —N⁺(R₁)₃, —N⁺(R₁)₂(R₂), —N⁺(R₁)(R₂)(R₃), —S(O)₂R₁, —S(O)₂OR₁, —S(O)₂NR₁R₂, —NR₁S(O)₂R₂, —NR₁C(O) R₂, —C(O)R₁, —C(O)OR₁, —C(O)NR₁R₂, —NR₁C(O)OR₂, —NR₁C(O)NR₁R₂, —OC(O)NR₁R₂, —NR₁S(O)₂NR₁R₂, —C(O)NR₁S(O)₂NR₁R₂, catechol, a boronic acid group, and a pyridyl disulfide group, where each R₁, R₂, and R₃ is independently H or linear or branched C₁₋₁₈ alkyl as well as —C(O)OCH₂CH₂—OH, —C(O)OCH₂CH₂—N(CH₃)₂, —C(O)OCH₂CH₂—N⁺(CH₃)₃, —C(O)OCH₂CH₂—OSO₃⁻, —C(O)OCH₂CH₂—OSO₃H, —C(O)OCH₂CH₂—SO₃⁻, —C(O)OCH₂CH₂—SO₃H, and —C(O)N(H)C((CH₃)₂)CH₂SO₃⁻, —C(O)N(H)C((CH₃)₂)CH₂SO₃H, wherein X is C, and wherein Y is C. The first water-soluble polymer has chemical structure as shown below:

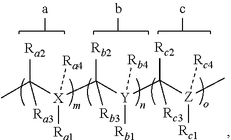

wherein unit a is the backbone unit and m is greater than 50% of the first water-soluble polymer based on molecular weight, wherein unit b is the first type of mucin binding unit and n is 1 unit to about 50% of the first water-soluble polymer based on molecular weight, wherein unit c is the second type of mucin binding unit and o is 1 unit to about 50% of the first water-soluble polymer based on molecular weight, wherein unit a and unit b are different from one another, Rₐ₁, Rₐ₂, Rₐ₃, Rₐ₄, R_{b1}, R_{b2}, R_{b3}, and R_{b4}, independently of one another, can be H, —OR₁, —NR₁R₂, —N⁺(R₁)₃, —N⁺(R₁)₂(R₂), —N⁺(R₁)(R₂)(R₃), —S(O)₂R₁, —S(O)₂OR₁, —S(O)₂NR₁R₂, —NR₁S(O)₂R₂, —NR₁C(O) R₂, —C(O)R₁, —C(O)OR₁, —C(O)NR₁R₂, —NR₁C(O)OR₂, —NR₁C(O)NR₁R₂, —OC(O)NR₁R₂, —NR₁S(O)₂NR₁R₂, —C(O)NR₁S(O)₂NR₁R₂, catechol, a boronic acid group, and a pyridyl disulfide group, where each R₁, R₂, and R₃ is independently H or linear or branched C₁₋₁₈ alkyl as well as —C(O)OCH₂CH₂—OH, —C(O)OCH₂CH₂—N(CH₃)₂, —C(O)OCH₂CH₂—N⁺(CH₃)₃, —C(O)OCH₂CH₂—OSO₃⁻, —C(O)OCH₂CH₂—OSO₃H, —C(O)OCH₂CH₂—SO₃⁻, —C(O)OCH₂CH₂—SO₃H, and —C(O)N(H)C((CH₃)₂)CH₂SO₃⁻, —C(O)N(H)C((CH₃)₂)CH₂SO₃H, wherein X is C, wherein Y is C, and wherein Z is C. Unit a, unit b, and unit c are different from one another. The first water-soluble polymer has chemical structure as shown below:

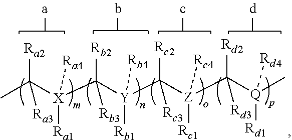

wherein unit a is the backbone unit and m is greater than 50% of the first water-soluble polymer based on molecular weight, wherein unit b is the first type of mucin binding unit and n is 1 unit to about 50% of the first water-soluble polymer based on molecular weight, wherein unit c is the second type of mucin binding unit and o is 1 unit to about 50% of the first water-soluble polymer based on molecular weight, wherein unit d is the second type of mucin binding unit and o is 1 unit to about 50% of the first water-soluble polymer based on molecular weight, wherein unit a and unit b are different from one another, Rₐ₁, Rₐ₂, Rₐ₃, Rₐ₄, R_{b1}, R_{b2}, R_{b3}, and R_{b4}, independently of one another, can be H, —OR₁, —NR₁R₂, —N⁺(R₁)₃, —N⁺(R₁)₂(R₂), —N⁺(R₁)(R₂)(R₃), —S(O)₂R₁, —S(O)₂OR₁, —S(O)₂NR₁R₂, —NR₁S(O)₂R₂, —NR₁C(O) R₂, —C(O)R₁, —C(O)OR₁, —C(O)NR₁R₂, —NR₁C(O)OR₂, —NR₁C(O)NR₁R₂, —OC(O)NR₁R₂, —NR₁S(O)₂NR₁R₂, —C(O)NR₁S(O)₂NR₁R₂, catechol, a boronic acid group, and a pyridyl disulfide group, where each R₁, R₂, and R₃ is independently H or linear or branched C₁₋₁₈ alkyl as well as —C(O)OCH₂CH₂—OH, —C(O)OCH₂CH₂—N(CH₃)₂, —C(O)OCH₂CH₂—N⁺(CH₃)₃, —C(O)OCH₂CH₂—OSO₃⁻, —C(O)OCH₂CH₂—OSO₃H, —C(O)OCH₂CH₂—SO₃⁻, —C(O)OCH₂CH₂—SO₃H, and —C(O)N(H)C((CH₃)₂)CH₂SO₃⁻, —C(O)N(H)C((CH₃)₂)CH₂SO₃H, wherein X is C, wherein Y is C, wherein Z is C, and wherein Q is C. Unit a, unit b, unit c, and unit d are different from one another. The first water-soluble polymer has a molecular weight of about 100 kDa to 10,000 kDa.

The present disclosure provides for a synthetic method of making a branched or hyperbranched first water-soluble polymer, comprising: polymerizing a backbone unit and at least one mucin-binding unit to form the branched or hyperbranched first water-soluble polymer, wherein the branched or hyperbranched first water-soluble polymer has a molecular weight of about 10 kDa to 10,000 kDa, wherein the branched or hyperbranched first water-soluble polymer includes a plurality of backbone units and at least one first type of a mucin-binding unit, wherein the backbone units comprise greater than 50% of the first water-soluble polymer based on molecular weight, wherein the first type of mucin-binding unit comprises of 1 unit up to 50% of the first water-soluble polymer based on molecular weight, wherein the first type of mucin-binding unit is functionalized so the water-soluble polymer has the characteristic of altering the hydration, rheology, or both of a mucin polymer, a second water-soluble polymer, or a combination thereof, wherein altering the hydration, rheology, or both is achieved through mucoadhesion, mucolability, mucointegration, or a combination thereof. The polymerization is cationic polymerization, anionic polymerization, ring-opening polymerization, or coordination polymerization. The polymerization is a radical polymerization, conventional radical polymerization, self condensing vinyl polymerization (SCVP), reversible-deactivation radical polymerization, reversible addition-fragmentation chain transfer (RAFT) polymerization, macromolecular design by interchange of xanthate (MADIX) polymerization, iniferter polymerization, atom transfer radical polymerization (ATRP), or stable free radical polymerization (SFRP). When the branched or hyperbranched first water-soluble polymer is formed the backbone unit is the reaction product of a multifunctional water soluble monomer and a water soluble monofunctional unit, wherein the mol % of the multifunctional water soluble monomer is less than 1% relative to the mol % of the monofunctional water soluble monomer. The monofunctional water soluble monomer contains one vinyl group or a functional group capable undergoing linear polymerization and wherein the multifunctional water soluble monomer that contains two or more vinyl or a functional group capable of undergoing radical polymerization. The monofunctional water soluble monomer is selected from N,N-dimethyl acrylamide (DMA), N-hydroxyethyl acrylamide (HEAm), or 2-methacryloyloxyethyl phosphorylcholine (MPC). The monofunctional water soluble monomer is N,N′-methylenebisacrylamide. The polymerization is a self condensing vinyl polymerization (SCVP) to form the hyperbranched first water-soluble polymer, wherein the backbone unit is a reaction product of a first inimer and a second inimer, wherein the first inimer and the second inimer contain a vinyl group and a group capable of initiating polymerization or capable of being transformed into a group capable of initiating polymerization. The first inimer and the second inimer are independently selected from the following structure:

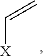

wherein X is CH₃. Hyperbranched first water-soluble polymer has a degree of branching (DB) larger than 0.4 but less than 1. Branched first water-soluble polymer has a degree of branching (DB) less than 0.4 but greater than 0. The mucin-binding unit comprises monomer units or copolymers that include the monomer units, wherein the monomer unit includes a functional group selected from the group consisting of: a boronic acid group, a carboxylate group, a carboxylic acid group, a hydrogen-bonding group, a hydrophobic group, a 1,2-diol group, a 1,3-diol group, a group capable of forming disulfide linkages, or a derivative of any one of these. The mucin-binding unit is selected from the group consisting of: acrylic acid, methacrylic acid, 4-vinylbenzoic acid, 4-(acrylamide)phenylboronic acid, 3-(acrylamide)phenylboronic acid, 2-(acrylamide)phenylboronic acid, 4-vinylphenylboronic acid, 3-vinylphenylboronic acid, 2-vinylphenylboronic acid, 2-(pyridin-2-yldisulfaneyl)ethyl methacrylate, pyridyl disulfide ethyl acrylate, pyridyl disulfide ethyl acrylamide, pyridyl disulfide alkyl (e.g. ethyl) methacrylamide 2-(pyridin-2-yldisulfaneyl)ethyl acrylate, 2-(pyridin-2-yldisulfaneyl)ethyl acrylamide, 2-(pyridin-2-yldisulfaneyl)ethyl methacrylate, or 2-(pyridin-2-yldisulfaneyl)ethyl methacrylate, (4-((2-acrylamidoethyl)carbamoyl)-3-chlorophenyl)boronic acid), (4-((2-acrylamidoethyl)carbamoyl)-3-fluorophenyl)boronic acid), (4-((2-acrylamidoethyl)carbamoyl)-3-bromophenyl)boronic acid), (4-((2-acrylamidoethyl)carbamoyl)-3-iodophenyl)boronic acid), a monomer including one or more boronic acid groups, a monomer containing one or more disulfide-forming groups, or a derivative of any one of these. The mucin-binding unit includes a functional group selected from the group consisting of: a boronic acid group, a carboxylate group, a carboxylic acid group, a hydrogen-bonding group, a hydrophobic group, a 1,2-diol group, a 1,3-diol group, and a group capable of forming disulfide linkages.

The present disclosure provides for compositions, comprising a first branched or hyperbranched water-soluble polymer having a molecular weight of about 10 kDa to 10,000 kDa, wherein the first branched or hyperbranched water-soluble polymer includes a plurality of backbone units and at least one first type of a mucin-binding unit, wherein the backbone units comprise greater than 50% of the first branched or hyperbranched water-soluble polymer based on molecular weight, wherein when the branched or hyperbranched first water-soluble polymer is formed the backbone unit is the reaction product of a multifunctional water soluble monomer and a water soluble monofunctional unit, wherein the mol % of the multifunctional water soluble monomer is less than 1% relative to the mol % of the monofunctional water soluble monomer, wherein the first type of mucin-binding unit comprises of 1 unit up to 50% of the first branched or hyperbranched water-soluble polymer based on molecular weight, wherein the first type of mucin-binding unit is functionalized so the first branched or hyperbranched water-soluble polymer has the characteristic of altering the hydration, rheology, or both of a mucin polymer, a second water-soluble polymer, or a combination thereof, wherein altering the hydration, rheology, or both is achieved through mucoadhesion, mucolability, mucointegration, or a combination thereof. The monofunctional water soluble monomer contains one vinyl group or a functional group capable undergoing linear polymerization and wherein the multifunctional water soluble monomer that contains two or more vinyl or a functional group capable of undergoing radical polymerization. The monofunctional water soluble monomer is selected from N,N-dimethyl acrylamide (DMA), N-hydroxyethyl acrylamide (HEAm), or 2-methacryloyloxyethyl phosphorylcholine (MPC). The monofunctional water soluble monomer is N,N′-methylenebisacrylamide. Hyperbranched first water-soluble polymer has a degree of branching (DB) larger than 0.4 but less than 1. Branched first water-soluble polymer has a degree of branching (DB) less than 0.4 but greater than 0. The first type of mucin binding unit is located solely at one or both terminal ends of the first water-soluble polymer. The first water-soluble polymer is a block copolymer. The first water-soluble polymer is a random copolymer. The first water-soluble polymer is a statistical copolymer. The first water-soluble polymer is an alternative copolymer. The first water-soluble polymer is a gradient copolymer. The block copolymer is an AB diblock copolymer or an ABA triblock copolymer, optionally wherein the mucin-binding units are isolated on the A block of the AB diblock copolymer or A block of the ABA triblock copolymer. The first water-soluble polymer has a molecular weight of about 100 kDa to 10,000 kDa.

The present disclosure provides for a composition, comprising a first branched or hyperbranched water-soluble polymer having a molecular weight of about 10 kDa to 10,000 kDa, wherein the first branched or hyperbranched water-soluble polymer includes a plurality of backbone units and at least one first type of a mucin-binding unit, wherein the backbone units comprise greater than 50% of the first branched or hyperbranched water-soluble polymer based on molecular weight, wherein the backbone unit is a reaction product of a first inimer and a second inimer, wherein the first inimer and the second inimer contain a vinyl group and a group capable of initiating polymerization or capable of being transformed into a group capable of initiating polymerization, wherein the first type of mucin-binding unit comprises of 1 unit up to 50% of the first branched or hyperbranched water-soluble polymer based on molecular weight, wherein the first type of mucin-binding unit is functionalized so the first branched or hyperbranched water-soluble polymer has the characteristic of altering the hydration, rheology, or both of a mucin polymer, a second water-soluble polymer, or a combination thereof, wherein altering the hydration, rheology, or both is achieved through mucoadhesion, mucolability, mucointegration, or a combination thereof. The first inimer and the second inimer are independently selected from the following structure:

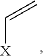

wherein X is CH₃. Hyperbranched first water-soluble polymer has a degree of branching (DB) larger than 0.4 but less than 1. Branched first water-soluble polymer has a degree of branching (DB) less than 0.4 but greater than 0. The first type of mucin binding unit is located solely at one or both terminal ends of the first water-soluble polymer. The first water-soluble polymer is a block copolymer. The first water-soluble polymer is a random copolymer. The first water-soluble polymer is a statistical copolymer. The first water-soluble polymer is an alternative copolymer. The first water-soluble polymer is a gradient copolymer. The block copolymer is an AB diblock copolymer or an ABA triblock copolymer, optionally wherein the mucin-binding units are isolated on the A block of the AB diblock copolymer or A block of the ABA triblock copolymer. The first water-soluble polymer has a molecular weight of about 100 kDa to 10,000 kDa.

The present disclosure provides for a composition, comprising a first water-soluble polymer having a molecular weight of about 10 kDa to 10,000 kDa, wherein the first water-soluble polymer includes a plurality of backbone units and at least one first type of a mucin-binding unit, wherein the backbone units comprise greater than 50% of the first water-soluble polymer based on molecular weight, wherein the first type of mucin-binding unit comprises of 1 unit up to 50% of the first water-soluble polymer based on molecular weight, wherein the first type of mucin-binding unit is functionalized so the first water-soluble polymer has the characteristic of altering the hydration, rheology, or both of a mucin polymer, a second water-soluble polymer, or a combination thereof, wherein altering the hydration, rheology, or both is achieved through mucoadhesion, mucolability, mucointegration, or a combination thereof; wherein the backbone unit comprises monomer units and copolymers including the monomer units, wherein the monomer unit is selected from the group consisting of: a substituted acrylamide or a substituted methacrylamide, or wherein the mucin-binding unit comprises monomer units or copolymers that include the monomer units, wherein the monomer unit is selected from the group consisting of: (4-((2-acrylamidoethyl)carbamoyl)-3-chlorophenyl)boronic acid), (4-((2-acrylamidoethyl)carbamoyl)-3-fluorophenyl)boronic acid), (4-((2-acrylamidoethyl)carbamoyl)-3-bromophenyl)boronic acid), (4-((2-acrylamidoethyl)carbamoyl)-3-iodophenyl)boronic acid)), a monomer including one or more boronic acid groups, a monomer containing one or more disulfide-forming groups, or a derivative of any one of these, wherein the backbone unit is N-hydroxyethyl acrylamide having the following structure:

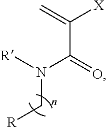

wherein n is 1 to 10, wherein R is a hydroxy group, an amine group, a carboxylate group, or a sulfonate group, wherein R′ is a C1 to C18 linear or branch alkyl group. The backbone unit comprises monomer units and copolymers including the monomer units, wherein the monomer unit is selected from the group consisting of: a substituted acrylamide or a substituted methacrylamide, and wherein the mucin-binding unit comprises monomer units or copolymers that include the monomer units, wherein the monomer unit is selected from the group consisting of: (4-((2-acrylamidoethyl)carbamoyl)-3-chlorophenyl)boronic acid), (4-((2-acrylamidoethyl)carbamoyl)-3-fluorophenyl)boronic acid), (4-((2-acrylamidoethyl)carbamoyl)-3-bromophenyl)boronic acid), (4-((2-acrylamidoethyl)carbamoyl)-3-iodophenyl)boronic acid)), a monomer including one or more boronic acid groups, a monomer containing one or more disulfide-forming groups, or a derivative of any one of these. The backbone unit comprises monomer units and copolymers including the monomer units, wherein the monomer unit is selected from the group consisting of: a substituted acrylamide or a substituted methacrylamide, and wherein the backbone unit is N-hydroxyethyl acrylamide having the following structure:

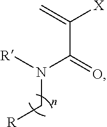

wherein n is 1 to 10, wherein R is a hydroxy group, an amine group, a carboxylate group, or a sulfonate group, wherein R′ is a C1 to C18 linear or branch alkyl group. The first water-soluble polymer has a structure that is linear or non-linear selected from the group consisting of star-like, branched, hyperbranched, cyclic, graph copolymer, or bottle brush-like. The first type of mucin binding unit is located solely at one or both terminal ends of the first water-soluble polymer. The first water-soluble polymer is a block copolymer. The first water-soluble polymer is a random copolymer. The first water-soluble polymer is a statistical copolymer. The first water-soluble polymer is an alternative copolymer. The first water-soluble polymer is a gradient copolymer. The block copolymer is an AB diblock copolymer or an ABA triblock copolymer, optionally wherein the mucin-binding units are isolated on the A block of the AB diblock copolymer or A block of the ABA triblock copolymer. The first water-soluble polymer has a molecular weight of about 100 kDa to 10,000 kDa.

### Example 1

We describe the synthesis of ultra-high molecular weight water-soluble polymers via photoiniferter polymerization under inverse miniemulsion conditions. The catalyst-free heterogeneous process is mediated using low-intensity UV irradiation and offers rapid polymerization rates, excellent molecular weight control, high polymer end-group fidelity, temporal control, advanced architectures, and most notably, viscosity control. We refined the polymerization conditions by considering the nature of the surfactant, costabilizer, and iniferter agent to achieve acrylamido homopolymers and block copolymers of molecular weights exceeding 1,000,000 Da at ambient temperature. This approach to well-defined ultra-high molecular weight polymers overcomes the complications of high viscosity to facilitate eventual scale-up.

### INTRODUCTION

Heterogeneous polymerization systems comprise approximately one-fifth of worldwide polymer production processes.¹⁻³ The prevalence of heterogeneous polymerizations arises from the advantages of viscosity control, improved heat transfer, high propagation rates, and the ability to produce high molecular weight polymers.^{3,4} These benefits largely result from the dispersion of insoluble monomer in stabilized droplets within a continuous phase where polymerization occurs in the locus of the droplets and the continuous phase acts as a heat sink for the exothermic polymerization. Importantly, the viscosity of the emulsion is approximately that of the continuous phase and is not significantly affected by the molecular weight of the growing polymer, unlike bulk and solution polymerization systems.

Heterogeneous polymerizations exhibit unique kinetics and rapid propagation rates and remain an active area of study.^{1,4-16} Miniemulsion polymerizations are of particular interest due to their enhanced colloidal stability and more uniform droplet size and composition, attributes associated with improved control of many living polymerization systems.^{9,17-20} Within miniemulsions, smaller particles of monomer are formed initially and serve as the loci of polymerization. Strong shearing is generally necessary to generate the high energy interfaces of the 50-500 nm diameter particles.^{17,21} Thus, the interfaces must be stabilized, typically with higher surfactant loadings and the addition of a costabilizer to limit monomer diffusion between droplets and particle coalescence.²¹ This approach has allowed miniemulsion monomer droplets to serve as nanoreactors for reversible-deactivation radical polymerization (RDRP), e.g., reversible addition-fragmentation chain-transfer (RAFT) polymerization, atom transfer radical polymerization (ATRP), and nitroxide mediated polymerization (NMP), among others.^{9,17,22-27} of note, the enhanced propagation rate and limited termination within these nanoreactors facilitate the formation of controlled ultra-high molecular weight polymers,^{20,28} which remains a challenge and focus for synthetic polymer chemists.²⁹⁻³⁸ Photoiniferter polymerization is an additional RDRP technique which we have employed to synthesize well-controlled ultra-high molecular weight (UHMW) polymers exceeding 1,000,000 Da.^{30,31} Specific reagents that can serve as initiators, transfer agents, and terminators have been coined iniferters and were initially explored for the synthesis of controlled polymers by Otsu in the early 1980's.^{39,40} Thiocarbonylthio photoiniferters of the basic structure ZC(═S)SR undergo homolytic bond photolysis upon irradiation with visible or UV light to generate two radicals: one that can initiate polymerization (R·) and another that serves as a stable radical capable of reversible-termination (Z(C═S)S·) to yield thiocarbonylthio end groups that permit degenerative chain transfer (FIG. 1.1C, Schemes A and B).⁴¹⁻⁴⁷ These polymerizations require no exogenous initiator beyond the photoiniferter. Temporal control is also imparted to these systems with the simple tuning of light intensity.

Evidence suggests that both reversible-termination and degenerative transfer processes are important for control during photoiniferter polymerization, where the predominant mechanism varies based on the structure of the iniferter.^{31,48,49} Judicious choice of conditions (i.e., high kₚ monomers, appropriate solvents, high monomer concentration, high viscosity, no exogenous initiator) allows an unprecedented opportunity to increase the ratio of rate of polymerization (Rₚ) to the rate of termination (Rₜ) to favor the formation of ultra-high molecular weight species.^{30,31,37,50,51} In particular, high viscosity, which is a consequence of the synthesis of the ultra-high molecular weight polymers, helps to suppress the rate of diffusion-controlled bimolecular reactions such as termination, and has been shown to be an important factor when targeting well-defined polymers of ultra-high molecular weights (10⁵-10⁷ Da). Unfortunately, the extremely high viscosities that enable access to such chain lengths may limit the eventual scale-up of such an approach. Photoiniferter polymerization has seen very limited exploration in (mini)emulsion systems,^{25,52-55} but given the benefits of the latter, where high viscosity is limited to the nano-scale reaction particles, we reasoned such an approach may have significant potential for scalable synthesis of ultra-high molecular weight polymers.

Here, we present the use of photoiniferter polymerization for the formation of well-controlled UHMW polymers under inverse miniemulsion conditions. Use of a heterogeneous system limits the viscosity of the overall solution while simultaneously helping to mitigate the polymerization exotherm. Translation of photoiniferter polymerization into a miniemulsion system serves as a significant step towards making this approach to UHMW polymers scalable and more industrially relevant, potentially facilitating their utility in a number of fields, including the production of flocculants, coacervates, protein mimetics, photonic materials, and elastomers.^{35,37,46,56-58}

### Results and Discussion

Initially we sought to explore the effect of various experimental conditions for the synthesis of UHMW (>10⁶ Da) poly(N,N-dimethylacrylamide) (PDMA) using photoiniferter polymerization under inverse miniemulsion conditions at ambient temperature (FIG. 1). We selected reaction components that had low UV cutoffs to limit absorption and maximize photolysis kinetics of the iniferter. Moreover, it was critical to select a thiocarbonylthio iniferter with suitable water solubility and reactivity to remain within the aqueous phase to effectively mediate polymerization. We also sought to identify surfactants and costabilizers that would afford stable particles on the order of ˜150 nm in diameter, which allowed access to UHMW polymers with controlled chain lengths and dispersities, good chain-end fidelity, and the on/off temporal control associated with photopolymerization.

Our initial goal was the formation of a miniemulsion with stable aqueous droplets dispersed in a continuous organic phase that would serve as nanoreactors for the polymerization of DMA. Cyclohexane was chosen as the continuous organic phase due to its immiscibility with water and low UV absorbance. The dispersed phase consisted of phosphate buffer (PB, pH=8), N,N-dimethylacrylamide (DMA), 2-(ethylthiocarbonothioylthio)propanoic acid (iniferter 1), and the internal standard N,N-dimethylformamide (DMF) to allow determination of monomer conversion via ¹H NMR spectroscopy. Initially, a [DMA]: [iniferter] ratio of 10,000:1 was chosen, where [DMA]=5 M within the aqueous phase, to target well-defined polymers of ˜1,000,000 Da (FIG. 1.1A). The miniemulsions were formed by sonicating the reaction components for 15 min.

Sorbitan monostearate (Span 60) was employed as the surfactant for droplet size and stability studies, as it is a common surfactant for traditional oil-in-water emulsions. Span 60 possesses a large 17-carbon hydrophobic tail coupled to a small hydrophilic sorbitan head and contains no unsaturated bonds or UV chromophores that might otherwise interfere with the polymerization. Surfactant loadings of 5, 7.5, 10, 12.5 and 15 wt % (relative to the dispersed phase) were tested for particle size and stability over 18 h of UV irradiation (Table S1). Particle size was monitored by dynamic light scattering (DLS), revealing particles with diameters of 120-140 nm across the surfactant loading range. However, significant macroscopic precipitation occurred during polymerization at the lower concentrations of 5 and 7.5 wt % surfactant loadings. Very minor precipitation was visible with 10 and 12.5 wt % surfactant loadings, and no significant precipitation with a surfactant load of 15 wt %. Span 60 was also blended with another surfactant, Tween 60, in an attempt to improve the particle stability (Table S2). However, the addition of Tween 60, which has a larger hydrophilic component, resulted in decreased particle stability as evidence by an initial increase in size by DLS and eventual macroscopic phase separation. Sodium chloride was also introduced to the system as a costabilizer to limit particle destabilization via Ostwald ripening (Table S3).²¹ NaCl was observed to enhance the stability of the particles as seen through decreased droplet dispersity via DLS early in the polymerization. A sample polymerization with the optimized salt and surfactant equivalents are shown in Table 1.

TABLE 1
Conditions for Optimized Inverse Miniemulsion Polymerization
of DMA at 30° C. and 1000 RPM Stir Rate

| | Reaction | Molar | Weight | Mass |
|---|---|---|---|---|
| Phase | Component | Equivalents | percent^{a} | (mg) |
| Dispersed | DMA | 10,000 | — | 500 |
| (aqueous) | iniferter | 1 | — | 0.106 |
| | PB pH 8 | — | — | 500 |
| | NaCl | — | 6 | 60 |
| | DMF | — | — | 106 |
| Surfactant | Span 60 | — | 15 | 150 |
| Continuous | Cyclohexane | — | — | 10,000 |
| (organic) | | | | |

^{a}Weight percent with respect to the total mass of monomer and water in the dispersed phase

As seen in FIG. 1.2A, the unreacted emulsion was optically clear after sonication (FIG. 1.2A). Solution clarity is dependent on the nano-scale droplet size in the system (FIG. 1.2B-1.2D), limited solids content, and similar refractive indices of cyclohexane and the 5 M DMA dispersed phase.^{1,59} Reducing the dispersed phase DMA concentration from 5 to 2 M resulted in an opaque solution, despite a small droplet size and identical mass ratio of dispersed phase to continuous phase.

Particle size of the inverse miniemulsion system was investigated using transmission electron microscopy (TEM) (FIG. 1.2C, 1.2D). To ensure particle stability during drop casting and imaging, the crosslinker N-methylenebisacrylamide (MBA) was included in a model polymerization at a concentration of 8 mol % relative to DMA. The crosslinker resulted in stable polymer particles amenable to TEM sample preparation. The number-average diameter (d_{N}) determined by TEM was 78 nm, which was in relatively good agreement with the d_{N} determined by DLS of 85 nm.

Ultra-high molecular weight polymers of-1,000,000 Da could be synthesized using iniferter 1 under the optimized inverse miniemulsion conditions. (FIG. 1.3A). Size exclusion chromatography (SEC) data suggested that synthesis of higher-molecular weight polymers was more challenging, potentially attributed to chain transfer reactions, presumably with surfactant. Notably, a polymer of molecular weight 1,210,000 Da was accessible by reducing the temperature from 30 to 10° C., an observation potentially consistent with the occurrence of chain transfer. For all polymerizations, the global viscosity of the system remained low, and the solutions readily flowed and were easily stirred with a magnetic stir bar (FIGS. 1.3B). As a comparison, the homogeneous aqueous polymerization of DMA in PB pH 8, with conditions mimicking the dispersed phase of the miniemulsion, produced a high-viscosity solution due to the high concentration of the UHMW PDMA (FIG. 1.3C).

To gain further insight into the controlled nature of this heterogeneous polymerization approach, polymerizations mediated with iniferter 1 were investigated in more detail (FIG. 1.4). For a polymerization targeting molecular weight of 1,000,000 Da at complete conversion, the experimental number-average molecular weight increased as a function of conversion and dispersity remained reasonable (Ð<1.4) throughout the polymerization (FIG. 1.4 A, B). Additionally, the linear pseudo-first-order kinetic plot indicated the radical concentration remained constant to high monomer conversion (FIG. 1.4C). DLS analysis revealed that the particle diameter did not change appreciably during the polymerization (FIG. 1.4D), as expected for miniemulsion systems, although a slight (and reversible) increase in particle size was consistently observed at lower conversions.

Photoiniferter polymerizations are controlled by a combination of reversible termination and degenerative chain transfer,^{31,48,49} and consideration must be given when selecting an iniferter for a given set of polymerization conditions. Accordingly, we explored other iniferters to determine the effect on polymerization control under inverse miniemulsion conditions (FIG. 5A, 5B, S9-S13). For an iniferter to effectively initiate and mediate polymerization in an aqueous medium, it must be stable to hydrolysis and have a water solubility sufficient for effective partitioning into the locus of polymerization, i.e., the water- and monomer-containing droplet.^{17,60,61}

Hydrolytic stability of iniferters 1-4 (FIG. 1.5A) was monitored using UV-vis spectroscopy, as hydrolysis of the trithiocarbonate would have deleterious effects on polymerization control.^{17,62,63} UV absorption spectra and molar extinction coefficients were determined for each iniferter in PB. Iniferters 1-4 were dissolved in PB and monitored by UV-vis spectroscopy for 18 h, during which time there was no change in the UV absorbance of iniferters 1, 2, or 4; however, iniferter 3 demonstrated a slight decrease in absorbance which could result from hydrolysis.^{62,63} The partitioning behavior of the iniferters in water/cyclohexane mixtures was monitored by UV-vis spectroscopy (FIG. 1.5C, 1.5D). The UV absorbances of iniferters 1-4 in PB were measure before and after the introduction of cyclohexane at concentrations relevant to polymerization conditions. In the absence of UV irradiation (mimicking the polymerization system prior to initiation), the UV absorbance of the iniferters did not change appreciably upon addition and mixing with cyclohexane. These results suggest that the iniferters favorably partition in the aqueous phase (FIG. 1.5C). When the biphasic reaction solutions were subjected to UV irradiation (mimicking the polymerization system upon initiation), all iniferters showed a decrease in absorbance intensity within the aqueous phase, indicating either loss of the intact iniferter or a reduction in concentration of the thiocarbonylthio fragment of the iniferter after homolytic bond cleavage (FIG. 1.5D). Interestingly, iniferters 2 and 3 exhibited slightly smaller decreases in absorbance intensity under UV irradiation, likely due to their carboxylate-containing Z groups, which could suggest that sulfur-centered thiocarbonylthiyl radicals with polar substituents are more likely to remain within the aqueous locus of polymerization after C—S bond cleavage by photolysis.

The rate of the photoiniferter polymerizations was predominately dictated by the nature of the light-absorbing thiocarbonylthio moiety within the photoiniferter, namely the trithiocarbonate (1-3) or the xanthate (4) (FIG. 1.5E). The water-soluble trithiocarbonates 1-3 resulted in polymerizations with similar rates (FIG. 1.5E) and allowed the synthesis of ultra-high molecular weight polymers in a controlled manner (FIG. 1.4, 1.5F), as evidenced by the number-average molecular weight of the polymers increasing linearly with monomer conversion and relatively narrow molecular weight distributions being observed via SEC. Iniferter 3, which contains carboxyl groups on both its R and Z groups that enhance solubility in the aqueous phase, resulted in the best combination of polymerization control and access to molecular weights in the range of 10⁶ Da (Table 2). The enhanced solubility of the thiocarbonylthio Z group of iniferter 3 in the locus of the polymerization potentially helped to limit loss to the organic phase of the thiocarbonylthiyl radicals that result from photolysis. Nevertheless, polymerization control was diminished when targeting Mₙ values greater than 2×10⁶ Da. Given that we have previously observed trithiocarbonates of this type to provide access to PDMA with Mₙ approaching 5×10⁶ Da when conducted in homogeneous aqueous media, this observation may again suggest complications arising from chain transfer to surfactant, though carrying out the polymerizations at a reduced temperature of 10° C. did not result in significantly improved control in this case.

Iniferter 4, a hydrophilic xanthate, failed to allow controlled polymerization, as evidenced by an unchanged Mₙ with increasing conversion (FIG. 1.5F). Xanthates undergo rapid photoexcitation and photolysis, and previous work has shown that they can be used as an iniferter to efficiently form UHMW polymers in a controlled manner.³¹ However, xanthates have a relatively low chain transfer constant to PDMA, suggesting reversible termination plays a more significant role in deactivation than when DMA polymerizations are mediated with a trithiocarbonate iniferter.^{31,48} Loss of control in miniemulsion conditions may suggest that partitioning of the thiocarbonylthiyl radical of iniferter 4 into the organic phase may compromise the effectiveness of reversible termination.

TABLE 2
Inverse miniemulsion photoiniferter polymerizations conducted with iniferter 3.

| Target | | | | | | | d_{z, after}^{g} |
|---|---|---|---|---|---|---|---|
| MW (Da) | Temp^{a} | Conv.^{b} | M_{n, theo}^{c} | M_{n, exp}^{d} | Ð^{e} | D_{z, prior}^{f}/ | (nm)/ |
| [DMA]:[iniferter] | (° C.) | (%) | (Da) | (Da) | (nm) | PDI | PDI |
| 1,000,000 | 30 | 93 | 918,000 | 1,030,000 | 1.23 | 130/0.10 | 150/0.08 |
| 10,000:1 | | | | | | | |
| 2,000,000 | 30 | >95 | 1,980,000 | 1,250,000 | 1.36 | 148/0.06 | 135/0.12 |
| 20,000:1 | | | | | | | |
| 5,000,000 | 30 | >95 | 4,960,000 | 1,550,000 | 1.35 | 125/0.16 | 119/1.15 |
| 50,000:1 | | | | | | | |
| 10,000,000 | 30 | >95 | 9,910,000 | 1,920,000 | 1.24 | 148/0.09 | 131/0.10 |
| 100,000:1 | | | | | | | |
| 1,000,000 | 10 | >95 | 992,000 | 1,290,000 | 1.32 | 152/0.10 | 130/0.13 |
| 10,000:1 | | | | | | | |
| 2,000,000 | 10 | >95 | 1,980,000 | 1,400,000 | 1.33 | 142/0.08 | 141/0.11 |
| 20,000:1 | | | | | | | |
| 5,000,000 | 10 | >95 | 4,960,000 | 1,720,000 | 1.22 | 146/0.11 | 124/0.12 |
| 50,000:1 | | | | | | | |
| 10,000,000 | 10 | >95 | 9,910,000 | 1,862,000 | 1.26 | 133/0.09 | 142/0.08 |
| 100,000:1 | | | | | | | |

All polymerizations were conducted for 12 h.
^{a}Polymerization temperature.
^{b}Monomer conversion determined by ¹H NMR spectroscopy.
^{c}Theoretical number-average molecular weight.
^{d}Experimental number-average molecular weight determined by SEC.
^{e}Final polymer chain dispersity.
^{f}Hydrodynamic diameter of the inverse miniemulsion particles prior to polymerization, as determined by DLS.
^{g}Hydrodynamic diameter of the inverse miniemulsion particles after polymerization, as determined by DLS.

The inverse miniemulsion polymerizations of DMA mediated with trithiocarbonate iniferters 1 and 3 were well-controlled as evidenced by the polymerization kinetics (FIG. 1.4, 1.5) and were expected to produce polymers with high end-group fidelity. To verify chain-end retention during the inverse miniemulsion conditions, PDMA prepared with iniferters 1 and 3 were chain extended in situ with additional DMA or 4-acryloyl morpholine (NMO) to synthesize a second block with a target molecular weight of 1,000,000 Da (FIG. 1.6). These block copolymerizations were carried out in a one-pot manner, wherein a solution of the second monomer in PB was added to the system when the initial PDMA homopolymer synthesis had reached ˜85+% monomer conversion. DLS indicated the polymer particles swelled with the addition of solvent and monomer. SEC traces of the original PDMA cleanly shifted to higher molecular weights during the addition of the second block, suggesting good chain-end retention.

Finally, we demonstrated that the temporal control typical of photopolymerizations was imparted to this inverse miniemulsion polymerization system (FIG. 1.7). Photoexcitation of the iniferter and radical formation only occurred when the light source was on. For the polymerization of DMA mediated by iniferter 1 under the conditions described in Table 1, little to no monomer conversion was observed when the light was off, and molecular weight increased only with increasing conversion during irradiation (FIG. 1.7A, C). Throughout the on-off light cycles, the particle size was constant, suggesting the polymerization particles remained stable over 16 h in the dark (FIG. 1.7D).

### CONCLUSIONS

The inverse miniemulsion system we designed serves as a model for the synthesis of well-controlled, UHMW PDMA by photoiniferter polymerization. The influence of reaction parameters such as surfactant loading, salt concentration, and iniferter identity all played important roles in controlling droplet size and enhancing molecular weight control. Appropriate choice of miniemulsion components enabled rapid synthesis of PDMA with a molecular weight exceeding 1,000,000 Da in a solution which maintained a low viscosity. UHMW polymers retained a high degree of chain-end fidelity evidenced by in situ chain extension that generated UHMW block copolymers without intermediate purification. Overall, the use of photoiniferter polymerization in a miniemulsion system is an important step to scalable production of UHMW materials with controlled molecular weight, chain-end retention, and complex architectures.

Ongoing work in our lab is focused on increasing the range of molecular weights that can be accessed by this approach.

### References for Example 1

(1) Jasinski, F.; Zetterlund, P. B.; Braun, A. M.; Chemtob, A. Photopolymerization in Dispersed Systems. Prog. Polym. Sci. 2018, 84, 47-88. https://doi.org/10.1016/j.progpolymsci.2018.06.006.
(2) Dinsmore, R. P. Synthetic Rubber and Method of Making It. U.S. Pat. No. 1,732,795A, Oct. 22, 1929.
(3) Odian, G. Emulsion Polymerization. In Principles of Polymerization. McGraw-Hill, Inc. 1970; pp 279-300.
(4) Khan, M.; Guimar§ es, T. R.; Zhou, D.; Moad, G.; Perrier, S.; Zetterlund, P. B. Exploitation of Compartmentalization in RAFT Miniemulsion Polymerization to Increase the Degree of Livingness. J. Polym. Sci. Part A Polym. Chem. 2019, 57, 1938-1946. https://doi.org/10.1002/pola.29329.
(5) Touve, M. A.; Figg, C. A.; Wright, D. B.; Park, C.; Cantlon, J.; Sumerlin, B. S.; Gianneschi, N. C. Polymerization-Induced Self-Assembly of Micelles Observed by Liquid Cell Transmission Electron Microscopy. ACS Cent. Sci. 2018, 4, 543-547. https://doi.org/10.1021/acscentsci.8b00148.
(6) Figg, C. A.; Simula, A.; Gebre, K. A.; Tucker, B. S.; Haddleton, D. M.; Sumerlin, B. S. Polymerization-Induced Thermal Self-Assembly (PITSA). Chem. Sci. 2015, 6, 1230-1236. https://doi.org/10.1039/C4SC03334E.
(7) Tan, J.; Sun, H.; Yu, M.; Sumerlin, B. S.; Zhang, L. Photo-PISA: Shedding Light on Polymerization-Induced Self-Assembly. ACS Macro Lett. 2015, 4, 1249-1253. https://doi.org/10.1021/acsmacrolett.5b00748.
(8) O'Bryan, C. S.; Kabb, C. P.; Sumerlin, B. S.; Angelini, T. E. Jammed Polyelectrolyte Microgels for 3D Cell Culture Applications: Rheological Behavior with Added Salts. ACS Appl. Bio Mater. 2019, 2, 1509-1517. https://doi.org/10.1021/acsabm.8b00784.
(9) Zetterlund, P. B.; Kagawa, Y.; Okubo, M. Controlled/Living Radical Polymerization in Dispersed Systems. Chem. Rev. 2008, 108, 3747-3794. https://doi.org/10.1021/cr800242x.
(10) Turro, N. J.; Chow, M.-F.; Chung, C.-J.; Tung, C.-H. An Efficient, High Conversion Photoinduced Emulsion Polymerization. Magnetic Field Effects on Polymerization Efficiency and Polymer Molecular Weight. J. Am. Chem. Soc. 1980, 102, 7391-7393. https://doi.org/10.1021/ja00544a053.
(11) Bianchi, J. P.; Price, F. P.; Zimm, B. H. “Monodisperse” Polystyrene. J. Polym. Sci. 1957, 25, 27-38. https://doi.org/10.1002/pol.1957.1202510803.
(12) Tobita, H. Effect of Small Reaction Locus in Free-Radical Polymerization: Conventional and Reversible-Deactivation Radical Polymerization. Polymers. 2016. https://doi.org/10.3390/polym8040155.
(13) Khan, M.; Guimarães, T. R.; Choong, K.; Moad, G.; Perrier, S.; Zetterlund, P. B. RAFT Emulsion Polymerization for (Multi)Block Copolymer Synthesis: Overcoming the Constraints of Monomer Order. Macromolecules 2021, 54, 736-746. https://doi.org/10.1021/acs.macromol.0c02415.
(14) Richardson, R. A. E.; Guimarães, T. R.; Khan, M.; Moad, G.; Zetterlund, P. B.; Perrier, S. Low-Dispersity Polymers in Ab Initio Emulsion Polymerization: Improved MacroRAFT Agent Performance in Heterogeneous Media. Macromolecules 2020, 53, 7672-7683. https://doi.org/10.1021/acs.macromol.OcOl311.
(15) Rho, J. Y.; Scheutz, G. M.; Hakkinen, S.; Garrison, J. B.; Song, Q.; Yang, J.; Richardson, R.; Perrier, S.; Sumerlin, B. S. In Situ Monitoring of PISA Morphologies. Polym. Chem. 2021, 12, 3947-3952. https://doi.org/10.1039/D1PY00239B.
(16) Scheutz, G. M.; Touve, M. A.; Carlini, A. S.; Garrison, J. B.; Gnanasekaran, K.; Sumerlin, B. S.; Gianneschi, N. C. Probing Thermoresponsive Polymerization-Induced Self-Assembly with Variable-Temperature Liquid-Cell Transmission Electron Microscopy. Matter 2021, 4, 722-736. https://doi.org/10.1016/j.matt.2020.11.017.
(17) Qi, G.; Jones, C. W.; Schork, F. J. RAFT Inverse Miniemulsion Polymerization of Acrylamide. Macromol. Rapid Commun. 2007, 28, 1010-1016. https://doi.org/10.1002/marc.200700026.
(18) Ferguson, C. J.; Hughes, R. J.; Nguyen, D.; Pham, B. T. T.; Gilbert, R. G.; Serelis, A. K.; Such, C. H.; Hawkett, B. S. Ab Initio Emulsion Polymerization by RAFT-Controlled Self-Assembly. Macromolecules 2005, 38, 2191-2204. https://doi.org/10.1021/ma048787r.
(19) Ferguson, C. J.; Hughes, R. J.; Pham, B. T. T.; Hawkett, B. S.; Gilbert, R. G.; Serelis, A. K.; Such, C. H. Effective Ab Initio Emulsion Polymerization under RAFT Control. Macromolecules 2002, 35, 9243-9245. https://doi.org/10.1021/ma025626j.
(20) Simms, R. W.; Cunningham, M. F. High Molecular Weight Poly(Butyl Methacrylate) by Reverse Atom Transfer Radical Polymerization in Miniemulsion Initiated by a Redox System. Macromolecules 2007, 40, 860-866. https://doi.org/10.1021/ma061899t.
(21) Asua, J. M. Miniemulsion Polymerization. Progress in Polymer Science (Oxford). Elsevier Ltd 2002, pp 1283-1346. https://doi.org/10.1016/S0079-6700(02)₀₀₀₁₀-2.
(22) Oh, J. K.; Tang, C.; Gao, H.; Tsarevsky, N. V; Matyjaszewski, K. Inverse Miniemulsion ATRP: A New Method for Synthesis and Functionalization of Well-Defined Water-Soluble/Cross-Linked Polymeric Particles. J. Am. Chem. Soc. 2006, 128, 5578-5584. https://doi.org/10.1021/ja060586a.
(23) Qi, G.; Eleazer, B.; W. Jones, C.; Joseph Schork, F. Mechanistic Aspects of Sterically Stabilized Controlled Radical Inverse Miniemulsion Polymerization. Macromolecules 2009, 42, 3906-3916. https://doi.org/10.1021/ma802741u.
(24) Zetterlund, P. B.; Okubo, M. Compartmentalization in Nitroxide-Mediated Radical Polymerization in Dispersed Systems. Macromolecules 2006, 39, 8959-8967. https://doi.org/10.1021/ma060841b.
(25) Tonnar, J.; Pouget, E.; Lacroix-Desmazes, P.; Boutevin, B. Synthesis of Poly(Vinyl Acetate)-Block-Poly(Dimethylsiloxane)-Block-Poly(Vinyl Acetate) Copolymers by Iodine Transfer Photopolymerization in Miniemulsion. Macromol. Symp. 2009, 281, 20-30. https://doi.org/10.1002/masy.200950703.
(26) Fan, W.; Tosaka, M.; Yamago, S.; Cunningham, M. F. Living Ab Initio Emulsion Polymerization of Methyl Methacrylate in Water Using a Water-Soluble Organotellurium Chain Transfer Agent under Thermal and Photochemical Conditions. Angew. Chemie Int. Ed. 2018, 57, 962-966. https://doi.org/10.1002/anie.201710754.
(27) Detrembleur, C.; Debuigne, A.; Bryaskova, R.; Charleux, B.; Jérôme, R. Cobalt-Mediated Radical Polymerization of Vinyl Acetate in Miniemulsion: Very Fast Formation of Stable Poly(Vinyl Acetate) Latexes at Low Temperature. Macromol. Rapid Commun. 2006, 27, 37-41. https://doi.org/10.1002/marc.200500645.
(28) Truong, N. P.; Dussert, M. V; Whittaker, M. R.; Quinn, J. F.; Davis, T. P. Rapid Synthesis of Ultrahigh Molecular Weight and Low Polydispersity Polystyrene Diblock Copolymers by RAFT-Mediated Emulsion Polymerization. Polym. Chem. 2015, 6, 3865-3874. https://doi.org/10.1039/C5PY00166H.
(29) Li, S.; Han, G.; Zhang, W. Photoregulated Reversible Addition-Fragmentation Chain Transfer (RAFT) Polymerization. Polym. Chem. 2020, 11, 1830-1844. https://doi.org/10.1039/DOPY00054J.
(30) Nicholas Carmean, R.; B. Sims, M.; Adrian Figg, C.; J. Hurst, P.; P. Patterson, J.; S. Sumerlin, B. Ultrahigh Molecular Weight Hydrophobic Acrylic and Styrenic Polymers through Organic-Phase Photoiniferter-Mediated Polymerization. ACS Macro Lett. 2020, 9, 613-618. https://doi.org/10.1021/acsmacrolett.0c00203.
(31) Carmean, R. N.; Becker, T. E.; Sims, M. B.; Sumerlin, B. S. Ultra-High Molecular Weights via Aqueous Reversible-Deactivation Radical Polymerization. Chem 2017, 2, 93-101. https://doi.org/10.1016/j.chempr.2016.12.007.
(32) Percec, V.; Guliashvili, T.; Ladislaw, J. S.; Wistrand, A.; Stjerndahl, A.; Sienkowska, M. J.; Monteiro, M. J.; Sahoo, S. Ultrafast Synthesis of Ultrahigh Molar Mass Polymers by Metal-Catalyzed Living Radical Polymerization of Acrylates, Methacrylates, and Vinyl Chloride Mediated by SET at 25° C. J. Am. Chem. Soc. 2006, 128, 14156-14165. https://doi.org/10.1021/ja065484z.
(33) Nicolaÿ, R.; Kwak, Y.; Matyjaszewski, K. A Green Route to Well-Defined High-Molecular-Weight (Co)Polymers Using ARGET ATRP with Alkyl Pseudohalides and Copper Catalysis. Angew. Chemie Int. Ed. 2010, 49, 541-544. https://doi.org/10.1002/anie.200905340.
(34) Read, E.; Guinaudeau, A.; James Wilson, D.; Cadix, A.; Violleau, F.; Destarac, M. Low Temperature RAFT/MADIX Gel Polymerisation: Access to Controlled Ultra-High Molar Mass Polyacrylamides. Polym. Chem. 2014, 5, 2202-2207. https://doi.org/10.1039/C3PY01750H.
(35) Hayashi, M.; Noro, A.; Matsushita, Y. Highly Extensible Supramolecular Elastomers with Large Stress Generation Capability Originating from Multiple Hydrogen Bonds on the Long Soft Network Strands. Macromol. Rapid Commun. 2016, 37, 678-684. https://doi.org/10.1002/marc.201500663.
(36) Liu, Z.; Lv, Y.; An, Z. Enzymatic Cascade Catalysis for the Synthesis of Multiblock and Ultrahigh-Molecular-Weight Polymers with Oxygen Tolerance. Angew. Chemie Int. Ed. 2017, 56, 13852-13856. https://doi.org/10.1002/anie.201707993.
(37) An, Z. 100th Anniversary of Macromolecular Science Viewpoint: Achieving Ultrahigh Molecular Weights with Reversible Deactivation Radical Polymerization. ACS Macro Lett. 2020, 9, 350-357. https://doi.org/10.1021/acsmacrolett.0c00043.
(38) Rzayev, J.; Penelle, J. HP-RAFT: A Free-Radical Polymerization Technique for Obtaining Living Polymers of Ultrahigh Molecular Weights. Angew. Chemie Int. Ed. 2004, 43, 1691-1694. https://doi.org/10.1002/anie.200353025.
(39) Otsu, T.; Yoshida, M. Role of Initiator-Transfer Agent-Terminator (Iniferter) in Radical Polymerizations: Polymer Design by Organic Disulfides as Iniferters. Die Makromol. Chemie, Rapid Commun. 1982, 3, 127-132. https://doi.org/10.1002/marc.1982.030030208.
(40) Otsu, T. Iniferter Concept and Living Radical Polymerization. J. Polym. Sci. Part A Polym. Chem. 2000, 38, 2121-2136. https://doi.org/10.1002/(SICl)1099-0518(20000615)38:12<2121::AID-POLA10>3.0.CO;2-X.
(41) Thum, M. D.; Wolf, S.; Falvey, D. E. State-Dependent Photochemical and Photophysical Behavior of Dithiolate Ester and Trithiocarbonate Reversible Addition-Fragmentation Chain Transfer Polymerization Agents. J. Phys. Chem. A 2020, 124, 4211-4222. https://doi.org/10.1021/acs.jpca.0c02678.
(42) McKenzie, T. G.; Fu, Q.; Wong, E. H. H.; Dunstan, D. E.; Qiao, G. G. Visible Light Mediated Controlled Radical Polymerization in the Absence of Exogenous Radical Sources or Catalysts. Macromolecules 2015, 48, 3864-3872. https://doi.org/10.1021/acs.macromol.5b00965.
(43) Otsu, T.; Matsunaga, T.; Kuriyama, A.; Yoshioka, M. Living Radical Polymerization through the Use of Iniferters: Controlled Synthesis of Polymers. Eur. Polym. J. 1989, 25, 643-650. https://doi.org/10.1016/0014-3057(89)90023-2.
(44) You, Y.-Z.; Hong, C.-Y.; Bai, R.-K.; Pan, C.-Y.; Wang, J. Photo-Initiated Living Free Radical Polymerization in the Presence of Dibenzyl Trithiocarbonate. Macromol. Chem. Phys. 2002, 203, 477-483. https://doi.org/10.1002/1521-3935(20020201)_{203:3<477}::AlD-MACP477>3.0.CO;2-M.
(45) Xu, J.; Shanmugam, S.; Corrigan, N. A.; Boyer, C. Catalyst-Free Visible Light-Induced RAFT Photopolymerization. In Controlled Radical Polymerization: Mechanisms; ACS Symposium Series; American Chemical Society, 2015; Vol. 1187, pp 13-247. https://doi.org/doi:10.1021/bk-2015-1187.chOl3.
(46) Liu, Y.; F. Santa Chalarca, C.; Nicholas Carmean, R.; A. Olson, R.; Madinya, J.; S. Sumerlin, B.; E. Sing, C.; Emrick, T.; L. Perry, S. Effect of Polymer Chemistry on the Linear Viscoelasticity of Complex Coacervates. Macromolecules 2020, 7851-7864. https://doi.org/10.1021/acs.macromol.0c00758.
(47) Carmean, R. N.; Figg, C. A.; Scheutz, G. M.; Kubo, T.; Sumerlin, B. S. Catalyst-Free Photoinduced End-Group Removal of Thiocarbonylthio Functionality. ACS Macro Lett. 2017, 6, 185-189. https://doi.org/10.1021/acsmacrolett.7b00038.
(48) Easterling, C. P.; Xia, Y.; Zhao, J.; Fanucci, G. E.; Sumerlin, B. S. Block Copolymer Sequence Inversion through Photoiniferter Polymerization. ACS Macro Lett. 2019, 8, 1461-1466. https://doi.org/10.1021/acsmacrolett.9b00716.
(49) Quinn, J. F.; Barner, L.; Barner-Kowollik, C.; Rizzardo, E.; Davis, T. P. Reversible Addition-Fragmentation Chain Transfer Polymerization Initiated with Ultraviolet Radiation. Macromolecules 2002, 35, 7620-7627. https://doi.org/10.1021/ma0204296.
(50) Storey, R. F. Fundamental Aspects of Living Polymerization. In Fundamentals of Controlled/Living Radical Polymerization; The Royal Society of Chemistry, 2013; pp 60-77. https://doi.org/10.1039/9781849737425-00060.
(51) Matyjaszewski, K. Ranking Living Systems. Macromolecules 1993, 26, 1787-1788. https://doi.org/10.1021/ma00059a048.
(52) Shim, S. E.; Shin, Y.; Jun, J. W.; Lee, K.; Jung, H.; Choe, S. Living-Free-Radical Emulsion Photopolymerization of Methyl Methacrylate by a Surface Active Iniferter (Suriniferter). Macromolecules 2003, 36, 7994-8000. https://doi.org/10.1021/ma034331i.
(53) Zhao, M.; Zhang, H.; Ma, F.; Zhang, Y.; Guo, X.; Zhang, H. Efficient Synthesis of Monodisperse, Highly Crosslinked, and “Living” Functional Polymer Microspheres by the Ambient Temperature Iniferter-Induced “Living” Radical Precipitation Polymerization. J. Polym. Sci. Part A Polym. Chem. 2013, 51, 1983-1998. https://doi.org/10.1002/pola.26579.
(54) Li, J.; Zu, B.; Zhang, Y.; Guo, X.; Zhang, H. One-Pot Synthesis of Surface-Functionalized Molecularly Imprinted Polymer Microspheres by Iniferter-Induced “Living” Radical Precipitation Polymerization. J. Polym. Sci. Part A Polym. Chem. 2010, 48, 3217-3228. https://doi.org/10.1002/pola.24057.
(55) Kwak, J.; Lacroix-Desmazes, P.; Robin, J. J.; Boutevin, B.; Torres, N. Synthesis of Mono Functional Carboxylic Acid Poly(Methyl Methacrylate) in Aqueous Medium Using Sur-Iniferter. Application to the Synthesis of Graft Copolymers Polyethylene-g-Poly(Methyl Methacrylate) and the Compatibilization of LDPE/PVDF Blends. Polymer. 2003, 44, 5119-5130. https://doi.org/10.1016/S0032-3861(03)₀₀₅₂₅-1.
(56) Mapas, J. K. D.; Thomay, T.; Cartwright, A. N.; llavsky, J.; Rzayev, J. Ultrahigh Molecular Weight Linear Block Copolymers: Rapid Access by Reversible-Deactivation Radical Polymerization and Self-Assembly into Large Domain Nanostructures. Macromolecules 2016, 49, 3733-3738. https://doi.org/10.1021/acs.macromol.6b00863.
(57) Dao, V. H.; Cameron, N. R.; Saito, K. Synthesis of UHMW Star-Shaped AB Block Copolymers and Their Flocculation Efficiency in High-Ionic-Strength Environments. Macromolecules 2019, 52, 7613-7624. https://doi.org/10.1021/acs.macromol.9b01290.
(58) Plucinski, A.; Pavlovic, M.; Schmidt, B. V. K. J. All-Aqueous Multi-Phase Systems and Emulsions Formed via Low-Concentration Ultra-High-Molar Mass Polyacrylamides. Macromolecules 2021, 54, 5366-5375. https://doi.org/10.1021/acs.macromol.1c00400.
(59) Sun, J. Z.; Erickson, M. C. E.; Parr, J. W. Refractive Index Matching and Clear Emulsions. J. Cosmet. Sci. 2005, 56, 253-265.
(60) Jung, K.; Boyer, C.; Zetterlund, P. B. RAFT Iniferter Polymerization in Miniemulsion Using Visible Light. Polym. Chem. 2017, 8, 3965-3970. https://doi.org/10.1039/C7PY00939A.
(61) Guimarães, T. R.; Bong, Y. L.; Thompson, S. W.; Moad, G.; Perrier, S.; Zetterlund, P. B. Polymerization-Induced Self-Assembly via RAFT in Emulsion: Effect of Z-Group on the Nucleation Step. Polym. Chem. 2021, 12, 122-133. https://doi.org/10.1039/D0PY01311K.
(62) B. Thomas, D.; J. Convertine, A.; D. Hester, R.; B. Lowe, A.; L. McCormick, C. Hydrolytic Susceptibility of Dithioester Chain Transfer Agents and Implications in Aqueous RAFT Polymerizations. Macromolecules 2004, 37, 1735-1741. https://doi.org/10.1021/ma035572t.
(63) V. Fuchs, A.; J. Thurecht, K. Stability of Trithiocarbonate RAFT Agents Containing Both a Cyano and a Carboxylic Acid Functional Group. ACS Macro Lett. 2017, 6, 287-291. https://doi.org/10.1021/acsmacrolett.7b00100.

### Example 2

This example describes the first successful controlled synthesis of ultra-high molecular weight (UHMW) polymers in excess of 10⁶ g/mol achieved via continuous flow in a tubular reactor. At high conversion, homogeneous UHMW batch polymerizations exhibit high viscosities that pose challenges for continuous flow reactors. However, under heterogeneous inverse mini emulsion (IME) conditions, UHMW polymers can be obtained within a dispersed phase while the viscosity of the heterogeneous solution remains approximately the viscosity of the continuous phase. Here, we discuss the kinetics of UHMW IME polymerizations conducted in flow and explore the range of molecular weights obtainable with this method. Furthermore, we show that UHMW IME polymerizations conducted in flow demonstrate a significant increase in rate while still exhibiting excellent control compared to batch solution and IME polymerizations.

### INTRODUCTION

In only a few decades since its discovery, reversible-deactivation radical polymerization (RDRP) has been leveraged to access polymers that can be applied in biomedicine, energy, and informatics.¹⁻⁸ The ability to precisely tune macromolecular properties (e.g., molecular weight, architecture, functionality) has led to deployment of RDRP for the synthesis of advanced materials across a wide range of size scales.⁹⁻¹⁶ While predetermined molecular weights are a defining feature of RDRP methods such as atom transfer radical polymerization (ATRP), nitroxide mediated polymerization (NMP), and reversible addition-fragmentation chain transfer (RAFT) polymerization, targeting molecular weights in excess of 10⁶ g/mol is challenging and typically requires specialized reaction conditions, such as high pressure.¹⁷⁻²⁵ However, recent investigations in RDRP have opened a new synthetic pathway to controlled polymer materials of ultra-high chain length utilizing mild conditions.²⁶ We recently demonstrated that long-wave ultraviolet (UV) irradiation of thiocarbonylthio compounds in the presence of vinyl monomers with high propagation rate constants (kₚ)in water yields ultra-high molecular weight (UHMW) polymers with predictable molecular weights.²⁷ In photoiniferter polymerization,²⁸ the thiocarbonylthio compound acts as a photoinitiator, chain transfer agent, and chain terminator. Importantly, this process eliminates the need for an exogenous radical initiator, which is employed in RAFT polymerization. The absence of exogenous radical initiator is essential to accessing UHMWs since the constant background generation of low molecular weight radicals limits chain length through bimolecular coupling in RAFT. Since this initial report describing controlled access to the UHMW regime, this method has been expanded to include monomers with lower kₚ, achieving more complex architectures, and utilizing lower-energy light sources.^{13,29,30}

The ability to initiate and mediate polymerization externally with light is central to the synthesis of UHMW polymers via photoiniferter. While light is an easily accessible and cheap external stimulus that imparts spatiotemporal control over chemical processes, scaling up photochemical batch reactions beyond the laboratory scale often presents significant issues.³¹ Batch reactors suffer from light attenuation commensurate with increasing reactor size according to the Beer-Lambert law.³² Accordingly, continuous flow reactors have been widely investigated as a method for scaling up controlled photopolymerizations using a variety of RDRP methods.³³⁻⁴² In addition to more efficient light penetration, the higher surface-area-to-volume ratio in tubular reactors also offers other benefits over batch reactors, such as uniform heat transfer and rate enhancement of photochemical processes.⁴³ While the synthesis of UHMW polymers via photoiniferter polymerization could benefit from translation to a tubular reactor, these polymerizations reach gel-like viscosities at high conversion, posing challenges for continuous flow.⁴⁴ Wang and coworkers overcame these high viscosities by dispersing aqueous polymerization droplets in n-octane, allowing for access to polyacrylamides with molecular weight over 10⁶ g/mol without clogging.⁴⁵ However, an RDRP method was not used in this system, limiting access to more advanced polymer architecture. Chen and coworkers utilized a similar surfactant-free droplet flow approach for polymerization of a variety of moderate molecular weight acrylates (ca. 10⁴ g/mol) via a controlled photo-RDRP mechanism.⁴⁶ Furthermore, while both of these methods successfully mitigate high viscosities reached during polymerization of concentrated solutions, special reactor design is necessary to achieve droplet flow conditions.

One method of mitigating polymerization viscosity is heterogeneous polymerization, wherein the loci of polymerization are dispersed into droplets within an immiscible continuous phase. We recently reported on an inverse miniemulsion (IME) batch system capable of synthesizing well-controlled UHMW polymers using photoiniferter polymerization. The appropriate choice of emulsion variables, such as surfactant loading and stabilizer concentration were optimized to create homogenously dispersed particles around 130 nm in diameter.⁴⁷ Polymerization of N,N-dimethylacrylamide (DMA) mediated by various thiocarbonylthio photoiniferter compounds was shown to reach molecular weights in excess of 10⁶ in a controlled fashion. Importantly, the macroscopic viscosity of this UHMW IME polymerizations was roughly equal to that of the cyclohexane continuous phase and remained constant as the polymerization progressed. In contrast UHMW solution polymerization viscosity increases four orders of magnitude over the course of the polymerization due to entanglement of ultra-high chain length polymers, yielding translation to continuous flow reactors challenging.⁴⁴ We hypothesize that dispersed IME UHMW polymerizations would allow for a pathway to synthesize well-controlled UHMW polymers in continuous flow.

Herein, we describe the controlled synthesis of UHMW polymers in IME conditions via a continuous-flow process utilizing various acrylamido monomers with water-soluble trithiocarbonate iniferters. Owing to the high surface-area-to-volume ratio afforded by the tubular reactor geometry, ultra-high molecular weights can be achieved in less than 1 h, allowing for a range of molecular weights (ca. 10⁴-10⁶) to be synthesized in a rapid fashion. Furthermore, translation to continuous flow aids in improving the scalability and industrial relevance of UHMW polymers synthesized by photoiniferter, which may facilitate their use in fields like photonic materials, coatings, or flocculents.⁴⁸⁻⁴⁹

### Results and Discussion

We initially investigated the synthesis of UHMW N,N-dimethylacrylamide (DMA) in a tubular flow reactor. Fluoropolymer tubing was wrapped around an aluminum cylinder and placed in an aluminum drum lined with 365 nm UV-LEDs (1 mW/cm²). The emulsion was prepared by mixing DMA, 2-(2-carboxyethylthiocarbonothioylthio)propanoic acid (PI 1), water, sodium chloride, and N,N-dimethylformamide (DMF) before adding Span-60 and cyclohexane (FIG. 2.1A). The resultant emulsion was sonicated, degassed, drawn into a syringe, and connected to the flow reactor via a syringe pump. The total retion time exposed to UV irradiation was 1 h and the monomer to photoiniferter ratio was 10,000:1. The resultant polymer reached near quantitative conversion, and characterization by gel permeation chromatography (GPC) showed good agreement with theoretical molecular weight (M_{n,theory}: 1.0×10⁶ g/mol, M_{n,GPC}: 1.10×10⁶ g/mol). An analogous batch polymerization with identical monomer to iniferter ratio was conducted for 1 h in a glass vial. At the same monomer concentration, the batch reaction only reached about 50% conversion (M_{n,theory}: 5.0×10⁵ g/mol, M_{n,GPC}: 4.9×10⁵ g/mol) in the same amount of time (FIG. 2.1B). This increase in polymerization rate is exhibited in the pseudo-first-order rate plot, in which the apparent propagation rate constant (k_{p,app}) of flow polymerizations increases relative to bach polymerizations (FIG. 2.1C). Similar rate increases over batch processes were previously reported by Junkers and coworkers for photoiniferter polymerizations conducted in continuous flow and can be attributed to increased surface-area-to-volume ratio in tubular reactors.⁴³ This enhanced polymerization rate suggests that this method shows promise in synthesizing libraries of polymers with various functionality and molecular weights in a rapid manner.

In order to ensure that polymerization control was maintained despite the increase in polymerization rate, we investigated the kinetics of IME polymerizations targeting UHMW in flow. An emulsion prepared in the same fashion as the previous flow experiment was subjected to the same polymerization conditions; however, the tubing of the reactor was divided into four equal fractions to allow for collection of polymerization aliquots every 15 min of retention time. Linear pseudo-first-order kinetics indicated that a constant radical concentration is maintained during the polymerization (FIG. 2.2A). Importantly, this suggests that the sulfur-centered radical product of homolytic cleavage of the PI does not leave the aqueous droplet during the polymerization, which would be observed as a negative deviation from linear behavior. Furthermore, sufficient light intensity to mediate consistent homolytic cleavage of the PI is maintained throughout the polymerization, despite changes in the optical clarity of the emulsion solution over the course of the polymerization. Previous studies have found that conducting polymerizations in the laminar flow regime can increase dispersity of polymer samples obtained in a continuous manner.⁵⁰ Furthermore, slippage and diffusion of miniemulsion droplets along fluoropolymer tubing walls has been shown to exacerbate this issue.⁵¹ However, in our system, over the course of the flow polymerization, molecular weights obtained via GPC agreed reasonably well with theoretical molecular weight calculated from monomer conversion (FIG. 2.3). The dispersity of the final polymer remained less than 1.3, which is comparable to polymerizations conducted in batch, suggesting the fluid dynamics of this reactor are suitable for achieving low-dispersity polymer samples in the UHMW regime.

Dispersed particle size and stability are crucial parameters of IME polymerizations. Emulsions are subjected to high shear conditions (e.g. sonication) to form miniemulsion particles on the order of 50-500 nm in diameter.⁴⁴ After sonication but before polymerization, these particles can undergo deleterious processes like Ostwald ripening and coalescence that increase particle size and dispersity.⁵² To determine if tubular flow conditions accelerate any adverse processes to the miniemulsion particles compared to batch reactions, we investigated particle stability in batch and in flow on timescales relevant to IME polymerizations by evaluating the particle size over time using dynamic light scattering (DLS). First, the emulsion mixture was subjected to ultrasonication, and the particle size was immediately measured by DLS (FIG. 2.4). The solution was then transferred to two sealed vials (stirred with a magnetic stir bar and static, respectively) and into a syringe placed in a syringe pump. The flow conditions mimicked those used during previous polymerizations (1 h retention time), and aliquots were removed from the batch conditions after 1 h. In both cases, the solutions were not irradiated with UV light to preclude any particle stabilization gained from polymerization. After one hour, DLS analysis of particles showed the average size of the particles increased slightly due to maturation of the emulsion, but batch and flow were comparable in both cases, suggesting that there are no significant differences in droplet behavior between batch and flow. Furthermore, we sought to ensure that the pre-polymerization emulsion in the syringe was sufficiently stable, as changes in the emulsion system prior to injection to the reactor could affect the molecular weight distributions of polymers obtained after multiple retention times. A polymerization was conducted in flow under UV irradiation, and the resultant polymer droplets were analyzed by DLS at various retention times. Gratifyingly, samples that were obtained after two and four full retention times (1 h retention time, samples collected at 2 h and 4 h) yielded near-identical particle size distributions and dispersities to the pre-polymerization emulsion. These results suggest that destabilization of the miniemulsion particles occurs on a much longer timescale than the retention time of this reaction. Thus, for UHMW IME processes on this scale, sonication yielded sufficiently stable particles to obtain well-controlled UHMW polymer distributions in flow.

TABLE 1
Ultra-High Molecular Weight Polymers Prepared via Photoiniferter
Polymerization in Inverse Mini Emulsion Conditions

| | | | M_{n, GPC} | M_{n, theory} | |
|---|---|---|---|---|---|
| Entry | Polymer | CTA | (g/mol) | (g/mol) | Ð |
| 1 | PDMA | PI 1 | 950,000 | 910,000 | 1.28 |
| 2 | PDMA | PI 2 | 1,120,000 | 1,000,000 | 1.34 |
| 3 | PDMA | PI 1 | 1,530,000 | 2,000,000 | 1.23 |
| 4 | PDMA | PI 1 | 1,720,000 | 5,000,000 | 1.40 |
| 5 | PDMA | PI 1 | 2,010,000 | 10,000,000 | 1.31 |
| 6 | PDMA | PI 1 | 507,000 | 500,000 | 1.28 |
| 7 | PDMA | PI 1 | 86,100 | 91,000 | 1.24 |
| 8 | PNAM | PI 2 | 548,000 | 560,000 | 1.34 |
| 9 | PNAM | PI 2 | 1,110,000 | 1,000,000 | 1.16 |

With this successful method for synthesizing UHMW polymers in a continuous manner established, we looked to explore the accessible range of molecular weights, photoiniferters, and monomer choice (Table 1). While reaching target molecular weights around 10⁶ g/mol could be achieved in a repeatable fashion, accessing molecular weights in excess of 1.5×10⁶ g/mol was challenging. For instance, targeting a molecular weight of 2.0×10⁶ yielded a polymer sample of 1.53×10⁶ g/mol despite complete monomer conversion. This constraint has also been documented in batch reactions and is attributed to chain transfer events.⁴⁷ Nevertheless, various molecular weights can be synthesized in continuous flow simply by altering the monomer-to-iniferter ratio. In this case, the amount of monomer was held constant to ensure similar dispersed particle volumes and only the iniferter loading was altered. The identity of the trithiocarbonate was varied and access to UHMW PDMA was also obtained using 2-(ethylthiocarbonothioylthio)propanoic acid (PI 2), indicating the utility of this method with a variety of water-soluble photoiniferters. Finally, the monomer scope was expanded to include 4-acryloylmorpholine (NAM), which yielded results comparable with UHMW IME polymerizations of DMA. We anticipate that this method is amenable to most water-soluble high-kₚ vinyl monomers polymerizable by photoiniferter.

Notably, one-pot chain extension of UHMW solution polymerization is challenging as the high viscosity limits homogenous diffusion of additional monomer into the macroinitiator solution. However, UHMW IME polymerizations allow for facile chain extension, as addition of water-soluble monomer preferentially partitions into the polymer droplets, where it can be subsequently incorporated into block copolymers.⁴⁷ Coupled with photoiniferter polymerization, this feature of IME polymerizations allows for facile access to UHMW block copolymers. We utilized this method for assessment of the chain-end retention during IME conditions carried out in flow. PDMA was synthesized in flow and collected in a vial. To this emulsion, DMA in phosphate buffer was added and allowed to swell the polymer droplets. GPC traces of the PDMA synthesized in flow clearly shift to lower retention times upon chain extension in batch conditions, indicating that the polymers synthesized in flow maintained good chain end fidelity. While this semi-batch process can allow for rapid synthesis of a library of macroinitiators in flow and subsequent chain extension in batch, a wholly continuous process to synthesize block copolymers via IME in flow remains challenging as commercially available in-line static mixers do not provide adequate mixing time for additional monomer to partition into polymer droplets, resulting in macrophase separation within the reactor tubing. We envision that these challenges could be overcome access by more complex reactor design, allowing for the synthesis of mutiblock copolymers in flow.

In conclusion, the methods described here provide a pathway to synthesize UHMW polymers in a continuous fashion. Due to more efficient light penetration in tubular reactors, we have shown that well-controlled polymers with molecular weights in excess of 10⁶ g/mol can be reached more rapidly in flow than in batch while maintaining polymerization control and chain-end fidelity. DLS experiments confirmed that IME particle sizes are stable in flow on timescales relevant for lab-scale synthesis of UHMW polymers. Overall, this method of synthesizing UHMW polymers in continuous flow presents a pathway to more readily access a wider range of UHMW polymers (e.g. varied functionality, functional group density, or molecular weight distribution shape) through the construction of more complex tubular reactor geometries. We expect that continuous synthesis of controlled UHMW polymers will not only expedite the study of UHMW materials for uses in fields such as biomaterials or photonic polymer materials but also aid in eventual scale-up of industrially relevant UHMW polymeric materials.

### References for Example 2

(1) Zhou, L.; Triozzi, A.; Figueiredo, M.; Emrick, T. Fluorinated Polymer Zwitterions: Choline Phosphates and Phosphorylcholines. ACS Macro Lett. 2021, 10, 1204-1209.
(2) Hill, M. R.; Carmean, R. N.; Sumerlin, B. S. Expanding the Scope of RAFT Polymerization: Recent Advances and New Horizons. Macromolecules 2015, 48, 5459-5469.
(3) Matyjaszewski, K.; Spanswick, J. Controlled/Living Radical Polymerization. Mater. Today 2005, 8, 26-33.
(4) Oliver, S.; Zhao, L.; Gormley, A. J.; Chapman, R.; Boyer, C. Living in the Fast Lane-High Throughput Controlled/Living Radical Polymerization. Macromolecules 2019, 52, 3-23.
(5) Kowalewski, T.; Tsarevsky, N. V.; Matyjaszewski, K. Nanostructured Carbon Arrays from Block Copolymers of Polyacrylonitrile. J. Am. Chem. Soc. 2002, 124, 10632-10633.
(6) Torres, R. M.; Sun, M.; Yuan, R.; Abdelrahman, M.; Guo, Z.; Kowalewski, T.;
Matyjaszewski, K.; Leduc, P. R.; Litster, S. Fe-Doped Copolymer-Templated Nitrogen-Rich Carbon as a PGM-Free Fuel Cell Catalyst. ACS Appl. Energy Mater. 2021, 2021, 9653-9663.
(7) Korpusik, A. B.; Tan, Y.; Garrison, J. B.; Tan, W.; Sumerlin, B. S. Aptamer-Conjugated Micelles for Targeted Photodynamic Therapy Via Photoinitiated Polymerization-Induced Self-Assembly. Macromolecules 2021, 54, 7354-7363.
(8) Siegwart, D. J.; Oh, J. K.; Matyjaszewski, K. ATRP in the Design of Functional Materials for Biomedical Applications. Prog. Polym. Sci. 2012, 37, 18.
(9) Sumerlin, B. S.; Neugebauer, D.; Matyjaszewski, K. Initiation Efficiency in the Synthesis of Molecular Brushes by Grafting from via Atom Transfer Radical Polymerization. Macromolecules 2005, 38, 702-708.
(10) Allison-Logan, S.; Karimi, F.; Sun, Y.; McKenzie, T. G.; Nothling, M. D.; Bryant, G.; Qiao, G. G. Highly Living Stars via Core-First Photo-RAFT Polymerization: Exploitation for Ultra-High Molecular Weight Star Synthesis. ACS Macro Lett. 2019, 8, 1291-1295.
(11) Wenn, B.; Martens, A. C.; Chuang, Y. M.; Gruber, J.; Junkers, T. Efficient Multiblock Star Polymer Synthesis from Photo-Induced Copper-Mediated Polymerization with up to 21 Arms. Polym. Chem. 2016, 7, 2720-2727.
(12) Gao, H.; Matyjaszewski, K. Synthesis of Star Polymers by a New “Core-First” Method: Sequential Polymerization of Cross-Linker and Monomer. Macromolecules 2008, 41, 1118-1125.
(13) Allison-Logan, S.; Karimi, F.; Sun, Y.; McKenzie, T. G.; Nothling, M. D.; Bryant, G.; Qiao,
G. G. Highly Living Stars via Core-First Photo-RAFT Polymerization: Exploitation for Ultra-High Molecular Weight Star Synthesis. ACS Macro Lett. 2019, 8, 1291-1295.
(14) Garrison, J. B.; Hughes, R. W.; Young, J. B.; Sumerlin, B. S. Photoinduced SET to Access Olefin-Acrylate Copolymers. Polym. Chem. 2022, 13, 982-988.
(15) Garrison, J. B.; Hughes, R. W.; Sumerlin, B. S. Backbone Degradation of Polymethacrylates via Metal-Free Ambient-Temperature Photoinduced Single-Electron Transfer. ACS Macro Lett. 2022, 441-446.
(16) Gody, G.; Maschmeyer, T.; Zetterlund, P. B.; Perrier, S. Exploitation of the Degenerative Transfer Mechanism in RAFT Polymerization for Synthesis of Polymer of High Livingness at Full Monomer Conversion. Macromolecules 2014, 47, 639-649.
(17) Truong, N. P.; Dussert, M. V.; Whittaker, M. R.; Quinn, J. F.; Davis, T. P. Rapid Synthesis of Ultrahigh Molecular Weight and Low Polydispersity Polystyrene Diblock Copolymers by RAFT-Mediated Emulsion Polymerization. Polym. Chem. 2015, 6, 3865-3874.
(18) Xu, J.; Jung, K.; Atme, A.; Shanmugam, S.; Boyer, C. A Robust and Versatile Photoinduced Living Polymerization of Conjugated and Unconjugated Monomers and Its Oxygen Tolerance. J. Am. Chem. Soc. 2014, 136, 5508-5519.
(19) Rzayev, J.; Penelle, J. HP-RAFT: A Free-Radical Polymerization Technique for Obtaining Living Polymers of Ultrahigh Molecular Weights. Angew. Chemie Int. Ed. 2004, 43, 1691-1694.
(20) Read, E.; Guinaudeau, A.; Wilson, D. J.; Cadix, A.; Violleau, F.; Destarac, M. Low Temperature RAFT/MADIX Gel Polymerisation: Access to Controlled Ultra-High Molar Mass Polyacrylamides. Polym. Chem. 2014, 5, 2202-2207.
(21) Simms, R. W.; Cunningham, M. F. High Molecular Weight Poly(Butyl Methacrylate) by Reverse Atom Transfer Radical Polymerization in Miniemulsion Initiated by a Redox System. Macromolecules 2007, 40, 860-866.
(22) Percec, V.; Guliashvili, T.; Ladislaw, J. S.; Wistrand, A.; Stjerndahl, A.; Sienkowska, M. J.; Monteiro, M. J.; Sahoo, S. Ultrafast Synthesis of Ultrahigh Molar Mass Polymers by Metal-Catalyzed Living Radical Polymerization of Acrylates, Methacrylates, and Vinyl Chloride Mediated by SET at 25° C. J. Am. Chem. Soc. 2006, 128, 14156-14165.
(23) Huang, Z.; Chen, J.; Zhang, L.; Cheng, Z.; Zhu, X. ICAR ATRP of Acrylonitrile under Ambient and High Pressure. Polym. 2016, Vol. 8, Page 59 2016, 8, 59.
(24) Mao, B. W.; Gan, L. H.; Gan, Y. Y. Ultra High Molar Mass Poly[2-(Dimethylamino)Ethyl Methacrylate] via Atom Transfer Radical Polymerization. Polymer (Guildf). 2006, 47, 3017-3020.
(25) Mueller, L.; Jakubowski, W.; Matyjaszewski, K.; Pietrasik, J.; Kwiatkowski, P.; Chaladaj, W.; Jurczak, J. Synthesis of High Molecular Weight Polystyrene Using AGET ATRP under High Pressure. Eur. Polym. J. 2011, 47, 730-734.
(26) An, Z. 100th Anniversary of Macromolecular Science Viewpoint: Achieving Ultrahigh Molecular Weights with Reversible Deactivation Radical Polymerization. ACS Macro Lett. 2020, 9, 350-357.
(27) Carmean, R. N.; Becker, T. E.; Sims, M. B.; Sumerlin, B. S. Ultra-High Molecular Weights via Aqueous Reversible-Deactivation Radical Polymerization. Chem 2017.
(28) Hartlieb, M. Photo-Iniferter RAFT Polymerization. Macromol. Rapid Commun. 2022, 43, 2100514.
(29) Carmean, R. N.; Sims, M. B.; Figg, C. A.; Hurst, P. J.; Patterson, J. P.; Sumerlin, B. S. Ultrahigh Molecular Weight Hydrophobic Acrylic and Styrenic Polymers through Organic-Phase Photoiniferter-Mediated Polymerization. ACS Macro Lett. 2020, 9, 613-618.
(30) Lewis, R. W.; Evans, R. A.; Malic, N.; Saito, K.; Cameron, N. R. Ultra-Fast Aqueous Polymerisation of Acrylamides by High Power Visible Light Direct Photoactivation RAFT Polymerisation. Polym. Chem. 2017, 9, 60-68.
(31) Junkers, T. Precision Polymer Design in Microstructured Flow Reactors: Improved Control and First Upscale at Once. Macromol. Chem. Phys. 2017, 218, 1600421.
(32) Harper, K. C.; Moschetta, E. G.; Bordawekar, S. V; Wittenberger, S. J. A Laser Driven Flow Chemistry Platform for Scaling Photochemical Reactions with Visible Light. 2019.
(33) Pan, X.; Tasdelen, M. A.; Laun, J.; Junkers, T.; Yagci, Y.; Matyjaszewski, K. Photomediated Controlled Radical Polymerization. Prog. Polym. Sci. 2016, 62, 73-125.
(34) Corrigan, N.; Rosli, D.; Jones, J. W. J.; Xu, J.; Boyer, C. Oxygen Tolerance in Living Radical Polymerization: Investigation of Mechanism and Implementation in Continuous Flow Polymerization. Macromolecules 2016, 49, 6779-6789.
(35) Railian, S.; Wenn, B.; Junkers, T. Photo-Induced Copper-Mediated Acrylate Polymerization in Continuous-Flow Reactors. J. Flow Chem. 2016, 6, 260-267.
(36) Chen, M.; Zhong, M.; Johnson, J. A. Light-Controlled Radical Polymerization: Mechanisms, Methods, and Applications. Chem. Rev. 2016, 116, 10167-10211.
(37) Ramsey, B. L.; Pearson, R. M.; Beck, L. R.; Miyake, G. M. Photoinduced Organocatalyzed Atom Transfer Radical Polymerization Using Continuous Flow. Macromolecules 2017, 50, 2668-2674.
(38) Corrigan, N.; Trujillo, F. J.; Xu, J.; Moad, G.; Hawker, C. J.; Boyer, C. Divergent Synthesis of Graft and Branched Copolymers through Spatially Controlled Photopolymerization in Flow Reactors. Macromolecules 2021, 54, 3430-3446.
(39) Judzewitsch, P. R.; Corrigan, N.; Trujillo, F.; Xu, J.; Moad, G.; Hawker, C. J.; Wong, E. H. H.; Boyer, C. High-Throughput Process for the Discovery of Antimicrobial Polymers and Their Upscaled Production via Flow Polymerization. Macromolecules 2020, 53, 631-639.
(40) Reis, M. H.; Leibfarth, F. A.; Pitet, L. M. Polymerizations in Continuous Flow: Recent Advances in the Synthesis of Diverse Polymeric Materials. ACS Macro Lett. 2020, 9, 123-133.
(41) Chen, K.; Zhou, Y.; Han, S.; Liu, Y.; Chen, M. Main-Chain Fluoropolymers with Alternating Sequence Control via Light-Driven Reversible-Deactivation Copolymerization in Batch and Flow. Angew. Chemie 2022, 134, e202116135.
(42) Wang, J.; Hu, X.; Zhu, N.; Guo, K. Continuous Flow Photo-RAFT and Light-PISA. Chem. Eng. J. 2021, 420, 127663.
(43) Rubens, M.; Latsrisaeng, P.; Junkers, T. Visible Light-Induced Iniferter Polymerization of Methacrylates Enhanced by Continuous Flow. Polym. Chem. 2017, 8, 6496-6505.
(44) Genggeng, Q.; Jones, C. W.; Schork, F. J. RAFT Inverse Miniemulsion Polymerization of Acrylamide. Macromol. Rapid Commun. 2007, 28, 1010-1016.
(45) Song, J.; Zhang, S.; Wang, K.; Wang, Y. Synthesis of Million Molecular Weight Polyacrylamide with Droplet Flow Microreactors. J. Taiwan Inst. Chem. Eng. 2019, 98, 78-84.
(46) Zhou, Y.; Gu, Y.; Jiang, K.; Chen, M. Droplet-Flow Photopolymerization Aided by Computer: Overcoming the Challenges of Viscosity and Facilitating the Generation of Copolymer Libraries. Macromolecules 2019, 52, 5611-5617.
(47) Olson, R. A.; Lott, M. E.; Garrison, J. B.; Davidson, C. L. G.; Trachsel, L.; Pedro, D. I.; Sawyer, W. G.; Sumerlin, B. S. Inverse Miniemulsion Photoiniferter Polymerization for the Synthesis of Ultrahigh Molecular Weight Polymers. Macromolecules 2022, 55, 8451-8460.
(48) Hsu, S. Y.; Kayama, Y.; Ohno, K.; Sakakibara, K.; Fukuda, T.; Tsujii, Y. Controlled Synthesis of Concentrated Polymer Brushes with Ultralarge Thickness by Surface-Initiated Atom Transfer Radical Polymerization under High Pressure. Macromolecules 2020, 53, 132-137.
(49) Dao, V. H.; Cameron, N. R.; Saito, K. Synthesis of UHMW Star-Shaped AB Block Copolymers and Their Flocculation Efficiency in High-lonic-Strength Environments. Macromolecules 2019, 52, 7613-7624.
(50) Reis, M. H.; Varner, T. P.; Leibfarth, F. A. The Influence of Residence Time Distribution on Continuous-Flow Polymerization. Macromolecules 2019, 52, 3551-3557.
(51) Russum, J. P.; Jones, C. W.; Schork, F. J. Impact of Flow Regime on Polydispersity in Tubular RAFT Miniemulsion Polymerization. AlChE J. 2006, 52, 1566-1576.
(52) Asua, J. M. Miniemulsion Polymerization. Prog. Polym. Sci. 2002, 27, 1283-1346.

It should be noted that ratios, concentrations, amounts, dimensions, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a range of “about 0.1% to about 5%” should be interpreted to include not only the explicitly recited range of about 0.1% to about 5%, but also include individual ranges (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to the numerical value and measurement technique. In addition, the phrase “about ‘x’ to ‘y’” includes “about ‘x’ to about ‘y’”.

It should be emphasized that the above-described embodiments of this disclosure are merely possible examples of implementations, and are set forth for a clear understanding of the principles of this disclosure. Many variations and modifications may be made to the above-described embodiments of this disclosure without departing substantially from the spirit and principles of this disclosure. All such modifications and variations are intended to be included herein within the scope of this disclosure and protected by the following claims.

1. A synthetic method of making a first water-soluble polymer, comprising: polymerizing a backbone unit and at least one mucin-binding unit to form the first water-soluble polymer using photoiniferter polymerization under inverse miniemulsion conditions.

2. The method of claim 1, wherein the method is a catalyst-free heterogeneous process that is mediated using low-intensity UV irradiation.

3. The method of claim 1, wherein the heterogeneous inverse miniemulsion processes includes one of the following characteristics: (1) the ability to prepare high molecular weight water-compatible polymers in a low viscosity, high solid form; (2) formation of water-in-oil emulsion of an aqueous solution of vinyl monomers in an inert hydrocarbon liquid organic dispersion medium; (3) formation of droplet particle size in the range of 50 to 500 nm; or (4) radically polymerizing said monomers in said dispersion medium to form polymeric droplets.

4. The method of claim 1, wherein the first water-soluble polymer having a molecular weight of about 10 kDa to 10,000 kDa, wherein the first water-soluble polymer includes a plurality of backbone units and at least one first type of a mucin-binding unit, wherein the backbone units comprise greater than 50% of the first water-soluble polymer based on molecular weight, wherein the first type of mucin-binding unit comprises of 1 unit up to 50% of the first water-soluble polymer based on molecular weight, wherein the first type of mucin-binding unit is functionalized so the water-soluble polymer has the characteristic of altering the hydration, rheology, or both of a mucin polymer, a second water-soluble polymer, or a combination thereof, wherein altering the hydration, rheology, or both is achieved through mucoadhesion, mucolability, mucointegration, or a combination thereof.

5. The method of claim 1, wherein the backbone unit comprises a monomer unit or a copolymer including the monomer unit, wherein the monomer unit is selected from the group consisting of: acrylamide, N,N-dimethylacrylamide, N,N-dialkylacrylamides, N-alkylacrylamides, N,N-dialkyl methacrylamides, N-alkyl methacrylamides, poly(ethlylene glycol) acrylate, poly(ethylene glycol) methacrylate, poly(ethylene glycol) acrylamide, and poly(ethylene glycol) methacrylamide.

6. The method of claim 1, wherein the backbone unit is N-hydroxyethyl acrylamide having the following structure: 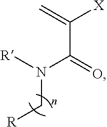
wherein n is 1 to 10, wherein R is a hydroxy group, an amine group, a carboxylate group, or a sulfonate group, wherein R′ is a C1 to C18 linear or branch alkyl group.

7. The method of claim 1, wherein the first water-soluble polymer has a structure that is non-linear selected from the group consisting of branched or hyperbranched.

8. The method of claim 1, wherein the mucin-binding unit comprises monomer units or copolymers that include the monomer units, wherein the monomer unit is selected from the group consisting of: acrylic acid, methacrylic acid, 4-vinylbenzoic acid, 4-(acrylamide)phenylboronic acid, 3-(acrylamide)phenylboronic acid, 2-(acrylamide)phenylboronic acid, 4-vinylphenylboronic acid, 3-vinylphenylboronic acid, 2-vinylphenylboronic acid, 2-(pyridin-2-yldisulfaneyl)ethyl methacrylate, pyridyl disulfide ethyl acrylate, pyridyl disulfide ethyl acrylamide, pyridyl disulfide alkyl (e.g. ethyl) methacrylamide 2-(pyridin-2-yldisulfaneyl)ethyl acrylate, 2-(pyridin-2-yldisulfaneyl)ethyl acrylamide, 2-(pyridin-2-yldisulfaneyl)ethyl methacrylate, or 2-(pyridin-2-yldisulfaneyl)ethyl methacrylate, (4-((2-acrylamidoethyl)carbamoyl)-3-chlorophenyl)boronic acid), (4-((2-acrylamidoethyl)carbamoyl)-3-fluorophenyl)boronic acid), (4-((2-acrylamidoethyl)carbamoyl)-3-bromophenyl)boronic acid), (4-((2-acrylamidoethyl)carbamoyl)-3-iodophenyl)boronic acid), a monomer including one or more boronic acid groups, a monomer containing one or more disulfide-forming groups, or a derivative of any one of these; or
wherein the mucin-binding unit comprises monomer units or copolymers that include the monomer units, wherein the monomer unit includes a functional group selected from the group consisting of: a boronic acid group, a carboxylate group, a carboxylic acid group, a hydrogen-bonding group, a hydrophobic group, a 1,2-diol group, a 1,3-diol group, a group capable of forming disulfide linkages or a derivative of any one of these.

9. The method of claim 1, wherein the first type of mucin binding unit is located solely at one or both terminal ends of the first water-soluble polymer.

10. A synthetic method of making a branched or hyperbranched first water-soluble polymer, comprising: polymerizing a backbone unit and at least one mucin-binding unit to form the branched or hyperbranched first water-soluble polymer, wherein the branched or hyperbranched first water-soluble polymer has a molecular weight of about 10 kDa to 10,000 kDa, wherein the branched or hyperbranched first water-soluble polymer includes a plurality of backbone units and at least one first type of a mucin-binding unit, wherein the backbone units comprise greater than 50% of the first water-soluble polymer based on molecular weight, wherein the first type of mucin-binding unit comprises of 1 unit up to 50% of the first water-soluble polymer based on molecular weight, wherein the first type of mucin-binding unit is functionalized so the water-soluble polymer has the characteristic of altering the hydration, rheology, or both of a mucin polymer, a second water-soluble polymer, or a combination thereof, wherein altering the hydration, rheology, or both is achieved through mucoadhesion, mucolability, mucointegration, or a combination thereof.

11. The synthetic method of claim 10, wherein the polymerization is a radical polymerization, conventional radical polymerization, self condensing vinyl polymerization (SCVP), reversible-deactivation radical polymerization, reversible addition-fragmentation chain transfer (RAFT) polymerization, macromolecular design by interchange of xanthate (MADIX) polymerization, iniferter polymerization, atom transfer radical polymerization (ATRP), or stable free radical polymerization (SFRP).

12. The synthetic method of claim 11, wherein when the branched or hyperbranched first water-soluble polymer is formed the backbone unit is the reaction product of a multifunctional water soluble monomer and a water soluble monofunctional unit, wherein the mol % of the multifunctional water soluble monomer is less than 1% relative to the mol % of the monofunctional water soluble monomer.

13. The synthetic method of claim 12, wherein hyperbranched first water-soluble polymer have a degree of branching (DB) larger than 0.4 but less than 1 or wherein branched first water-soluble polymer have a degree of branching (DB) less than 0.4 but greater than 0.

14. The synthetic method of claim 11, wherein the mucin-binding unit includes a functional group selected from the group consisting of: a boronic acid group, a carboxylate group, a carboxylic acid group, a hydrogen-bonding group, a hydrophobic group, a 1,2-diol group, a 1,3-diol group, and a group capable of forming disulfide linkages.

15. A composition, comprising a first branched or hyperbranched water-soluble polymer having a molecular weight of about 10 kDa to 10,000 kDa, wherein the first branched or hyperbranched water-soluble polymer includes a plurality of backbone units and at least one first type of a mucin-binding unit, wherein the backbone units comprise greater than 50% of the first branched or hyperbranched water-soluble polymer based on molecular weight, wherein when the branched or hyperbranched first water-soluble polymer is formed the backbone unit is the reaction product of a multifunctional water soluble monomer and a water soluble monofunctional unit, wherein the mol % of the multifunctional water soluble monomer is less than 1% relative to the mol % of the monofunctional water soluble monomer, wherein the first type of mucin-binding unit comprises of 1 unit up to 50% of the first branched or hyperbranched water-soluble polymer based on molecular weight, wherein the first type of mucin-binding unit is functionalized so the first branched or hyperbranched water-soluble polymer has the characteristic of altering the hydration, rheology, or both of a mucin polymer, a second water-soluble polymer, or a combination thereof, wherein altering the hydration, rheology, or both is achieved through mucoadhesion, mucolability, mucointegration, or a combination thereof.

16. The composition of claim 15, wherein the monofunctional water soluble monomer contains one vinyl group or a functional group capable undergoing linear polymerization and wherein the multifunctional water soluble monomer that contains two or more vinyl or a functional group capable of undergoing radical polymerization.

17. The composition of claim 16, wherein the monofunctional water soluble monomer is selected from N,N-dimethyl acrylamide (DMA), N-hydroxyethyl acrylamide (HEAm), 2-methacryloyloxyethyl phosphorylcholine (MPC) or N,N′-methylenebisacrylamide.

18. The composition of claim 15, wherein hyperbranched first water-soluble polymer has a degree of branching (DB) larger than 0.4 but less than 1 or wherein the branched first water-soluble polymer has a degree of branching (DB) greater than 0 but less than 0.4.

19. The composition of claim 15, wherein the first type of mucin binding unit is located solely at one or both terminal ends of the first water-soluble polymer.

20. The composition of claim 15, wherein the first water-soluble polymer has a molecular weight of about 100 kDa to 10,000 kDa.
